(19) United States
(12) Patent Application Publication
(10) Pub. No.: US 2018/0176614 A1
(43) Pub. Date: Jun. 21, 2018

(54) Methods and Systems for Caching Content for a Personalized Video

(71) Applicant: FACEBOOK, INC., Menlo Park, CA (US)

(72) Inventors: Boyan Lin, Menlo Park, CA (US); Peter Tuchen Lai, Mountain View, CA (US)

(21) Appl. No.: 15/387,419

(22) Filed: Dec. 21, 2016

(51) Int. Cl. H04N 21/231; G06F 12/0806; G06F 12/0875; G11B 27/031

(52) U.S. Cl. CPC H04N 21/23106; G06F 12/0806; G06F 2212/455; G11B 27/031; G06F 2212/62; G06F 12/0875

(57) ABSTRACT

An exemplary method to cache content for a personalized video includes storing a first tier of images in a first image cache. The images of the first tier are included in a personalized video for a user. Storing a second tier of images in a second image cache. The images of the second tier are alternatives to the images of the first tier. The method further includes providing the personalized video to the user for editing, comprising retrieving the first tier of images from the first image cache and sending the first tier of images to a client device of the user. The method further includes providing the second tier of images to the user as selectable replacements for the first tier of images, comprising retrieving the second tier of images from the second image cache and sending the second tier of images to the client device of the user.

### TECHNICAL FIELD

This relates generally to caching content, including but not limited to caching (e.g., storing) content for a personalized video.

### BACKGROUND

Social networking services provide a convenient means for users of the social networking service to share information (e.g., post an image). Social networking services may, on occasion, select and generate content for their users using stored user content. Storing and retrieving the user content, however, can be expensive and inefficient, and subject to both human and machine-based inaccuracies.

### SUMMARY

Accordingly, there is a need for methods and systems for caching (e.g., storing) user content used by social networking services (e.g., caching one or more tiers of images). Storing portions of the content in respective content caches can improve the social networking service's ability to effectively retrieve the user content and generate other content for users of the social networking services (e.g., a personalized video). Such methods and systems provide social networking services with processes to provide personalized content to users on a large scale.

In accordance with some embodiments, a method is performed at a server system having processors and memory storing instructions for execution by the processors. The method includes storing a first tier of images in a first image cache. The images of the first tier are included in a personalized video for a user. The method further includes storing a second tier of images in a second image cache. The images of the second tier are alternatives to the images of the first tier. The method further includes providing the personalized video to the user for editing, comprising retrieving the first tier of images from the first image cache and sending the first tier of images to a client device of the user. The method further includes providing the second tier of images to the user as selectable replacements for the first tier of images, comprising retrieving the second tier of images from the second image cache and sending the second tier of images to the client device of the user.

In accordance with some embodiments, a server system includes one or more processors/cores, memory, and one or more programs; the one or more programs are stored in the memory and configured to be executed by the one or more processors/cores and the one or more programs include instructions for performing the operations of the method described above. In accordance with some embodiments, a computer-readable storage medium has stored therein instructions which when executed by one or more processors/cores of a server system, cause the server system to perform the operations of the method described above.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an exemplary network architecture of a social network in accordance with some embodiments.

FIG. 2 is a block diagram illustrating an exemplary server system in accordance with some embodiments.

FIG. 3 is a block diagram illustrating an exemplary client device, in accordance with some embodiments.

FIGS. 4A-4J illustrate exemplary graphical user interfaces (GUIs) of a personalized video for a user of a social networking system on a client device, in accordance with some embodiments.

FIGS. 5A-5D are flow diagrams illustrating a method of generating a personalized video for a user of a social networking system, in accordance with some embodiments.

FIGS. 6A-6E illustrate exemplary graphical user interfaces (GUIs) of a personalized video editor for a user of a social networking system on a client device, in accordance with some embodiments.

FIGS. 7A-7D are flow diagrams illustrating a method of editing a personalized video for a user of a social networking system, in accordance with some embodiments.

FIGS. 8A-8B are flow diagrams illustrating a method 800 of storing and providing content for a personalized video to a user of a social networking system, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first metric could be termed a second metric, and, similarly, a second metric could be termed a first metric, without departing from the scope of the various described embodiments. The first metric and the second metric are both metrics, but they are not the same metric.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

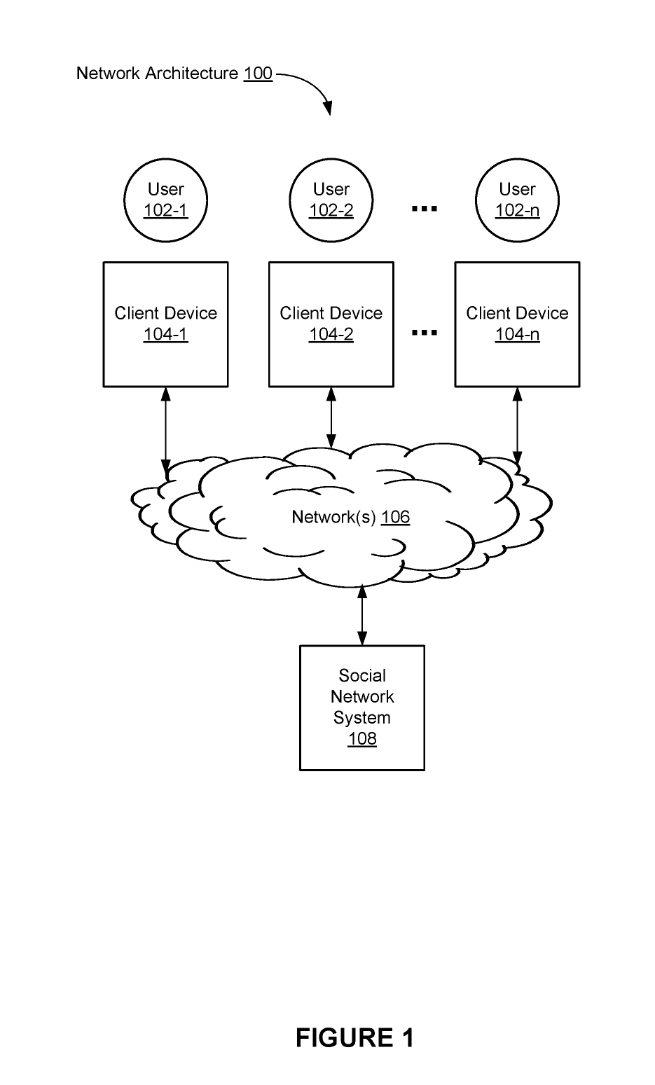

FIG. 1 is a block diagram illustrating an exemplary network architecture of a social network in accordance with some embodiments. The network architecture 100 includes a number of client devices (also called “client systems,” “client computers,” or “clients”) 104-1, 104-2, . . . 104-n communicably connected to a social network system 108 (also referred to herein as a social networking system) by one or more networks 106.

In some embodiments, the client devices 104-1, 104-2, . . . 104-n are computing devices such as smart watches, personal digital assistants, portable media players, smart phones, tablet computers, 2D gaming devices, 3D gaming devices, virtual reality devices, laptop computers, desktop computers, televisions with one or more processors embedded therein or coupled thereto, in-vehicle information systems (e.g., an in-car computer system that provides navigation, entertainment, and/or other information), or other appropriate computing devices that can be used to communicate with an electronic social network system and other computing devices (e.g., via the electronic social network system). In some embodiments, the social network system 108 is a single computing device such as a computer server, while in other embodiments, the social network system 108 is implemented by multiple computing devices working together to perform the actions of a server system (e.g., cloud computing). In some embodiments, the network 106 is a public communication network (e.g., the Internet or a cellular data network), a private communications network (e.g., private LAN or leased lines), or a combination of such communication networks.

Users 102-1, 102-2, . . . 102-n employ the client devices 104-1, 104-2, . . . 104-n to access the social network system 108 and to participate in a social networking service. For example, one or more of the client devices 104-1, 104-2, . . . 104-n execute web browser applications that can be used to access the social networking service. As another example, one or more of the client devices 104-1, 104-2, . . . 104-n execute software applications that are specific to the one or more social networks (e.g., social networking “apps” running on smart phones or tablets, such as a Facebook social networking application, a messaging application, etc., running on an iPhone, Android, or Windows smart phone or tablet).

Users interacting with the client devices 104-1, 104-2, . . . 104-n can participate in the social networking service provided by the social network system 108 by providing and/or consuming (e.g., posting, writing, viewing, publishing, broadcasting, promoting, recommending, sharing) information, such as text comments (e.g., statuses, updates, announcements, replies, location “check-ins,” private/group messages), digital content (e.g., photos (i.e., images), videos, audio files, links, documents), and/or other electronic content. In some embodiments, users provide information to a page, group, message board, feed, and/or user profile of a social networking service provided by the social network system 108. Users of the social networking service can also annotate information posted by other users of the social networking service (e.g., endorsing or “liking” a posting of another user, commenting on a posting by another user, or sharing a posting of another user).

In some embodiments, information can be posted on a user's behalf by systems and/or services external to the social network or the social network system 108. For example, the user may post a review of a movie to a movie review website, and with proper permissions that website may cross-post the review to the social network on the user's behalf. In another example, a software application executing on a mobile client device, with proper permissions, may use a global navigation satellite system (GNSS) (e.g., global positioning system (GPS), GLONASS, etc.) or other geo-location capabilities (e.g., Wi-Fi or hybrid positioning systems) to determine the user's location and update the social network with the user's location (e.g., “At Home,” “At Work,” or “In San Francisco, Calif.”), and/or update the social network with information derived from and/or based on the user's location. Users interacting with the client devices 104-1, 104-2, . . . 104-n can also use the social network provided by the social network system 108 to define groups of users. Users interacting with the client devices 104-1, 104-2, . . . 104-n can also use the social network provided by the social network system 108 to communicate (e.g., using a messaging application or built-in feature) and collaborate with each other.

In some embodiments, the network architecture 100 also includes third-party servers (not shown). In some embodiments, third-party servers are associated with third-party service providers who provide services and/or features to users of a network (e.g., users of the social network system 108, FIG. 1).

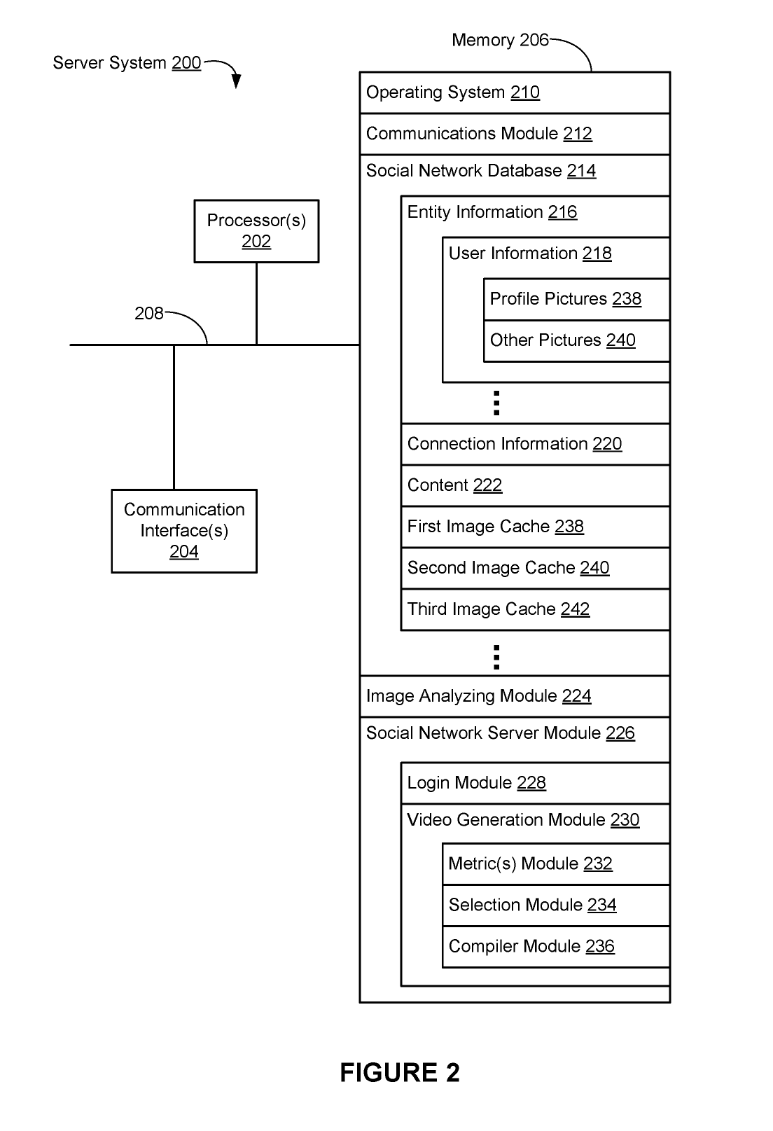

FIG. 2 is a block diagram illustrating an exemplary server system 200 in accordance with some embodiments. In some embodiments, the server system 200 is an example of a social network system 108. The server system 200 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The server system 200 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

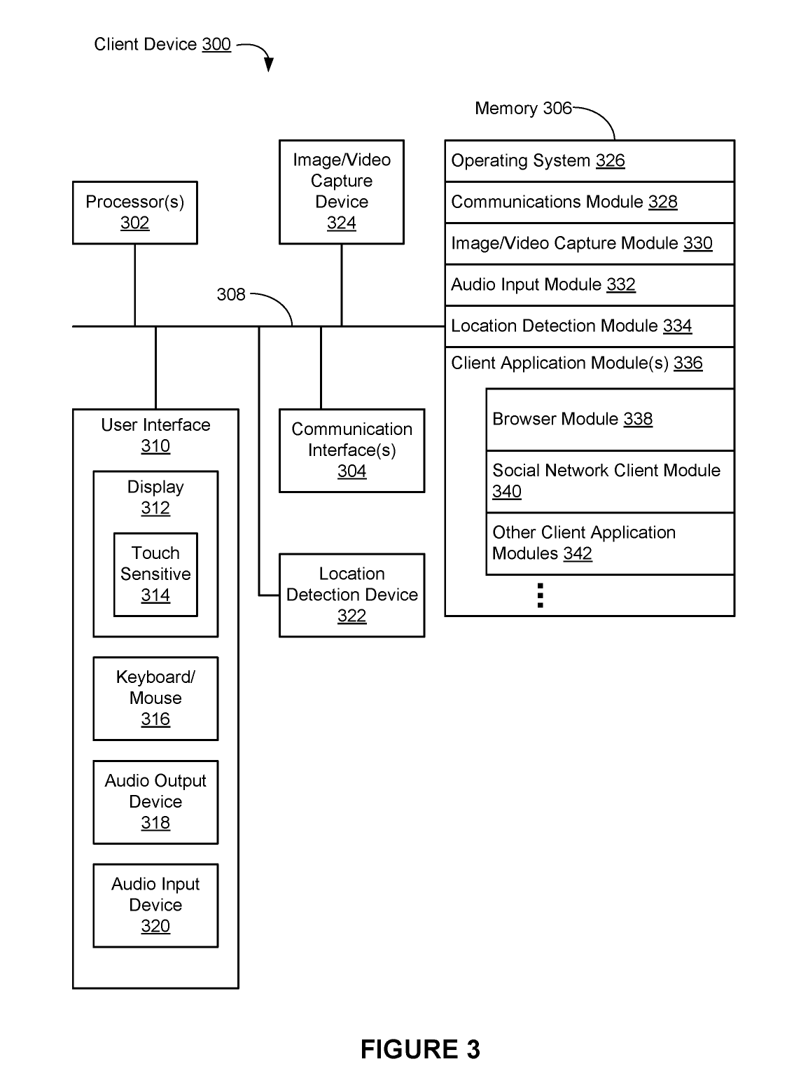

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some embodiments, memory 206 or the computer readable storage medium of memory 206 stores the following programs, modules, and data structures, or a subset or superset thereof:
an operating system 210 that includes procedures for handling various basic system services and for performing hardware dependent tasks;
a network communication module 212 that is used for connecting server system 200 (e.g., social network system 108, FIG. 1) to other computers (e.g., client devices 104-1, 104-2, . . . 104-n, and/or third party servers) via the one or more communication network interfaces 204 (wired or wireless) and one or more communication networks, such as the Internet, cellular telephone networks, mobile data networks, other wide area networks, local area networks, metropolitan area networks, and so on;
a social network database 214 for storing data associated with the social networking service, such as:
   entity information 216, such as user information 218, which includes user profile pictures 242 and other pictures associated with the user 244;
   connection information 220;
   user content 222;
   a first image cache 238;
   a second image cache 240; and
   a third image cache 242;
image analysis module 224 that operates upon images received by the server system 200 to detect and/or track subjects (e.g., people, pets, and other objects) in the images;
a social network server module 226 for providing social networking services and related features (e.g., in conjunction with social network client module 340 on the client device 104, FIG. 3), which includes:
   a login module 228 for logging a user 102 at a client device 104 into the social network system 108;
   a video generator module 230 for generating a personalized video for the user 102 and providing the personalized video to a client device 104 of the user 102, which includes:
      metric(s) module 232 for determining a metric (e.g., a score) for respective images associated with the user 102;
      selection module 234 for selecting images to include in the personalized video for the user 102; and
      compiler module 236 for compiling the images, along with text slides, to generate the personalized video for the user 102.

The social network database 214 stores data associated with the server system 200 in one or more types of databases, such as graph, dimensional, flat, hierarchical, network, object-oriented, relational, and/or XML databases.

In some embodiments, the social network database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities, some of which are rendered at clients 104 (e.g., client device 300, FIG. 3) on corresponding profile pages or other pages in the social networking service. In some embodiments, the nodes also include pointers or references to other objects, data structures, or resources for use in rendering content in conjunction with the rendering of the pages corresponding to the respective nodes at clients 104.

Entity information 216 includes user information 218, such as user profiles, user profile pictures, other pictures associated with the user (e.g., images where the user has been tagged or identified by image analysis software), a plurality of icons, login information, payment credentials (e.g., credit-card or debit-card information, bank information, etc. for conducting financial transactions through the social networking service), privacy and other preferences, biographical data, and the like. In some embodiments, for a given user, the user information 218 includes the user's name, profile picture, a plurality of icons, contact information, birth date, sex, marital status, family status, employment, education background, preferences, interests, and/or other demographic information. In some embodiments, the user information may include other information, such as likes and comments, associated with say, profile pictures of the user (or other photos of the user).

In some embodiments, entity information 216 includes information about a physical location (e.g., a restaurant, theater, landmark, city, state, or country), real or intellectual property (e.g., a sculpture, painting, movie, game, song, idea/concept, photograph, or written work), a business, a group of people, and/or a group of businesses. In some embodiments, entity information 216 includes information about a resource, such as an audio file, a video file, a digital photo, a text file, a structured document (e.g., web page), or an application. For example, entity information 216 may include a location tag (e.g., Lake Tahoe, Calif., USA) for one or more digital photos. In some embodiments, the resource is located in the social network system 108 (e.g., in content 222) or on an external server, such as a third-party server (not shown).

In some embodiments, connection information 220 includes information about the relationships between entities in the social network database 214. In some embodiments, connection information 220 includes information about edges that connect pairs of nodes in a graph database. In some embodiments, an edge connecting a pair of nodes represents a relationship between the pair of nodes (e.g., also referred to herein as a contact).

In some embodiments, an edge includes or represents one or more data objects or attributes that correspond to the relationship between a pair of nodes. For example, when a first user indicates that a second user is a “friend” of the first user, the social network system 108 transmits a “friend request” to the second user. If the second user confirms the “friend request,” the social network system 108 creates and stores an edge connecting the first user's user node and the second user's user node in a graph database as connection information 220 that indicates that the first user and the second user are friends. In some embodiments, connection information 220 represents a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In some embodiments, an edge between a user node and another entity node represents connection information 220 about a particular action or activity performed by a user of the user node towards the other entity node. For example, a user may “like” or have “attended,” “played,” “listened,” “cooked,” “worked at,” “watched,” etc. the entity at the other node. The page in the social networking service that corresponds to the entity at the other node may include, for example, a selectable “like,” “check in,” “add to favorites,” etc. icon. After the user clicks one of these icons, the social network system 108 may create a “like” edge, “check in” edge, a “favorites” edge, etc. in response to the corresponding user action. As another example, the user may listen to a particular song using a particular application (e.g., an online music application). In this case, the social network system 108 may create a “listened” edge and a “used” edge between the user node that corresponds to the user and the entity nodes that correspond to the song and the application, respectively, to indicate that the user listened to the song and used the application. In addition, the social network system 108 may create a “played” edge between the entity nodes that correspond to the song and the application to indicate that the particular song was played by the particular application.

In some embodiments, content 222 includes text (e.g., ASCII, SGML, HTML), images (e.g., jpeg, tif and gif), graphics (e.g., vector-based or bitmap), audio, video (e.g., mpeg), other multimedia, and/or combinations thereof. In some embodiments, content 222 includes executable code (e.g., script for API calls), podcasts, links, and the like.

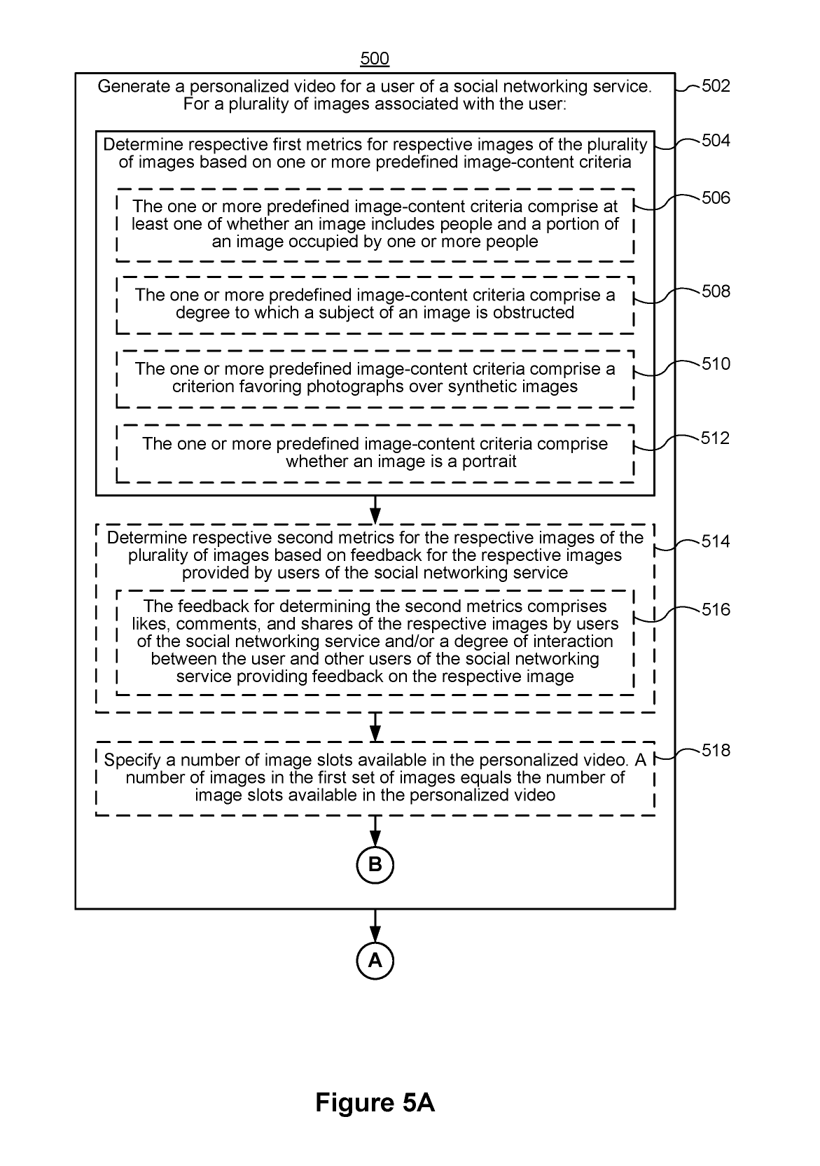

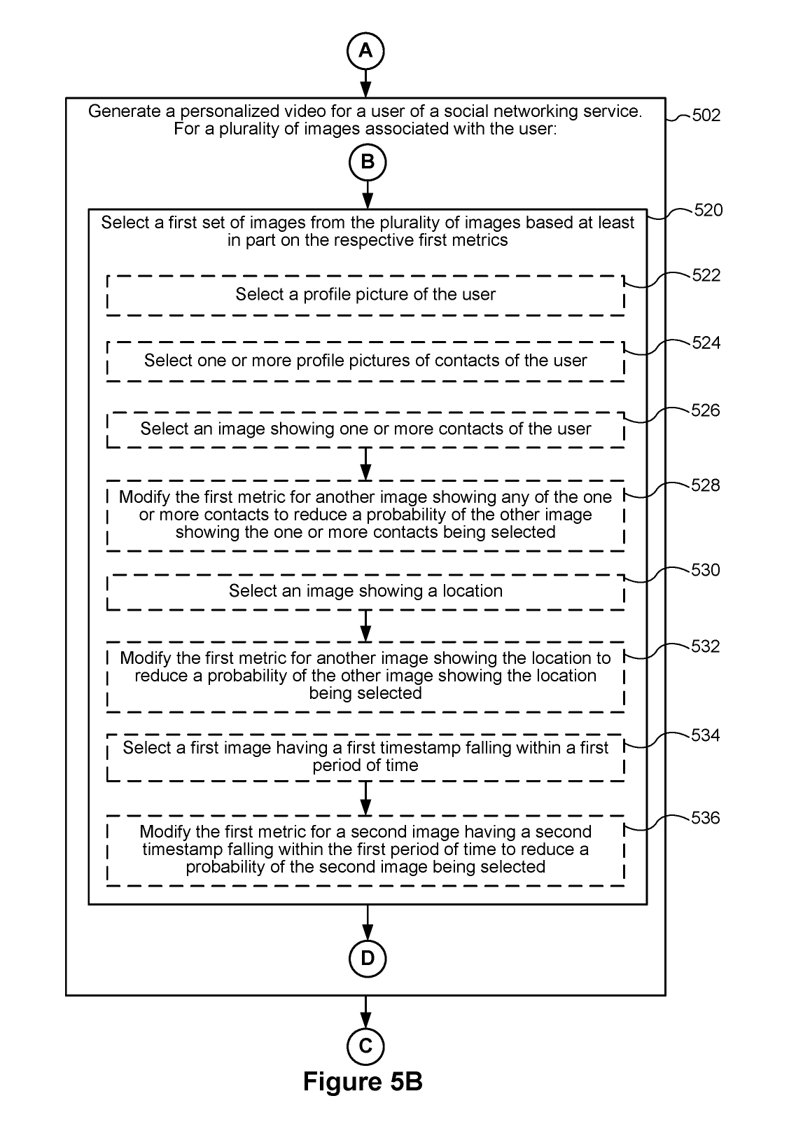

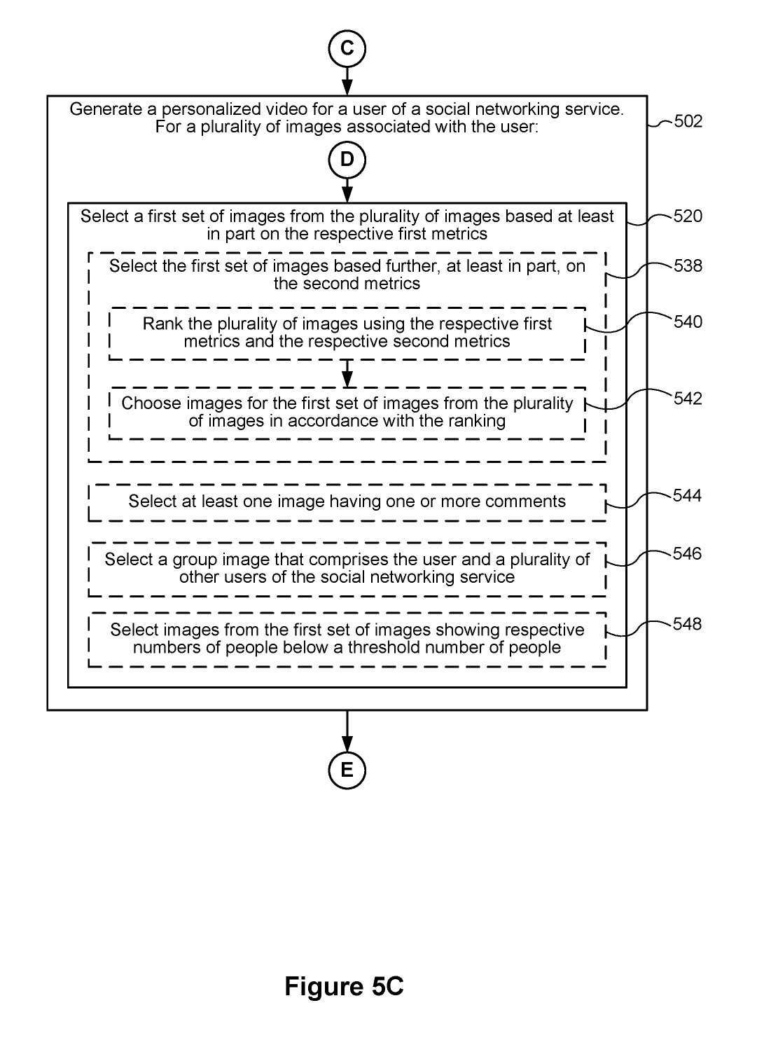

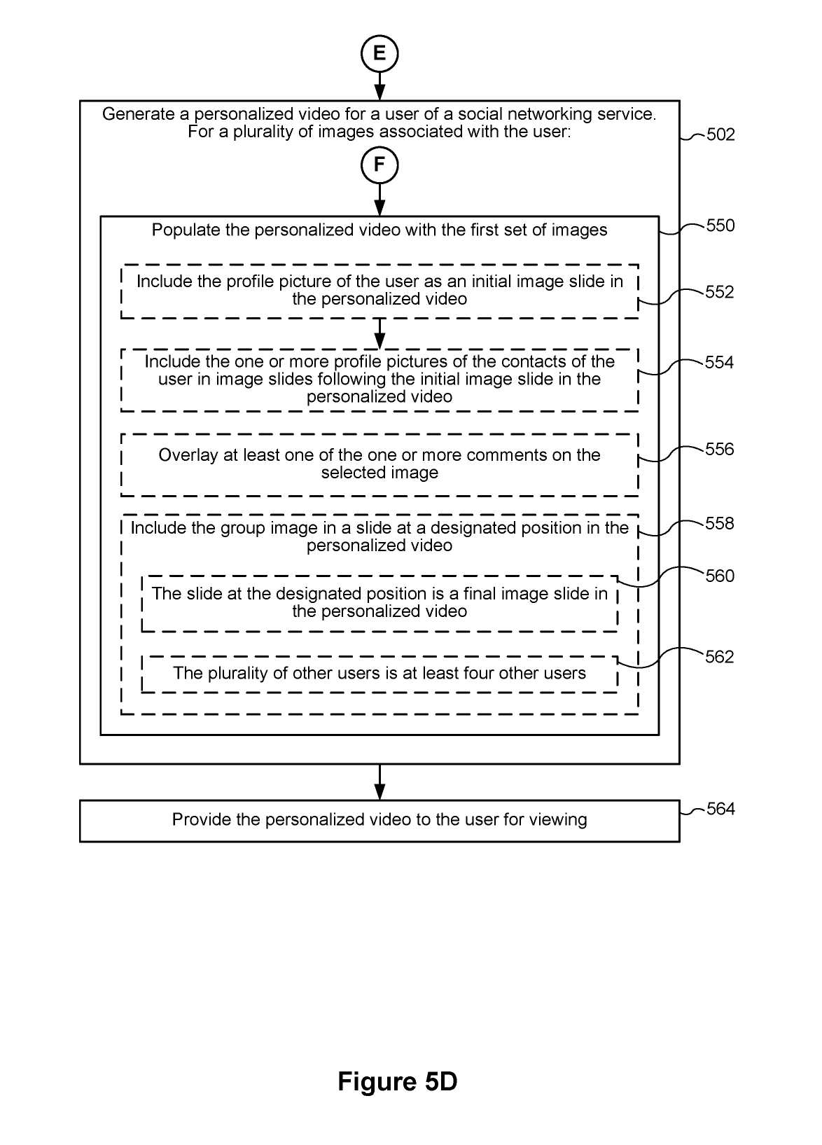

In some embodiments, the first image cache 238 may store a first tier of images. The first tier of images may be an example of a first set of images, discussed in further detail below with reference to FIGS. 5A-5D.

In some embodiments, the second image cache 240 may store a second tier of images. In some embodiments, the second tier of images may be an example of a second set of images as discussed below with reference to FIG. 5D. In addition, in some embodiments, the second tier of images may be a subset of images of the second set of images.

In some embodiments, the third image cache 242 may store a third tier of images. In some embodiments, the third tier of images may be an example of a third set of images as discussed below with reference to FIG. 5D. Alternatively or in addition, in some embodiments, the third tier of images may be a group of images from the subset of images of the second set of images.

In some embodiments, the first image cache 238, the second image cache 240, and the third image cache 242 may be subcaches of a single image cache. Accordingly, in some embodiments, the single image cache may store the first, second, and third tiers of images.

FIG. 3 is a block diagram illustrating an exemplary client device 300, in accordance with some embodiments. The client device 300 is an example of the one or more client devices 104-1, 104-2, . . . 104-n (FIG. 1). The client device 300 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 300 includes a user interface 310. The user interface 310 typically includes a display device 312. In some embodiments, the client device 300 includes inputs such as a keyboard, mouse, and/or other input buttons 316. Alternatively or in addition, in some embodiments, the display device 312 includes a touch-sensitive surface 314, in which case the display device 312 is a touch-sensitive display. In some embodiments, the touch-sensitive surface 314 is configured to detect various swipe gestures (e.g., continuous gestures in vertical and/or horizontal directions) and/or other gestures (e.g., single/double tap). In client devices that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 300 use a microphone and voice recognition to supplement or replace the keyboard. Optionally, the client device 300 includes an audio input device 320 (e.g., a microphone) to capture audio (e.g., speech from a user). Optionally, the client device 300 includes a location detection device 322, such as a GNSS (e.g., GPS, GLONASS, etc.) or other geo-location receiver, for determining the location of the client device 300. The client device 300 also optionally includes an image/video capture device 324, such as a camera and/or a webcam.

In some embodiments, the client device 300 includes one or more optional sensors (e.g., gyroscope, accelerometer) for detecting motion and/or a change in orientation of the client device. In some embodiments, the detected motion and/or orientation of the client device 300 (e.g., the motion/change in orientation corresponding to a user input produced by a user of the client device) is used to manipulate an interface (or content within the interface) displayed on the client device 300. In some embodiments, the one or more optional sensors may include an optical projection sensor for projecting an interface displayed on the client device 300 in 3D (e.g., project 3D hologram). Moreover, a user may manipulate the interface displayed on the client device 300 by interacting with the projected holographic 3D display.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 302. Memory 306, or alternately the non-volatile memory device(s) within memory 306, includes a non-transitory computer-readable storage medium. In some embodiments, memory 306 or the computer-readable storage medium of memory 306 stores the following programs, modules, and data structures, or a subset or superset thereof:
an operating system 326 that includes procedures for handling various basic system services and for performing hardware dependent tasks;
a network communication module 328 that is used for connecting the client device 300 to other computers via the one or more communication network interfaces 304 (wired or wireless) and one or more communication networks, such as the Internet, cellular telephone networks, mobile data networks, other wide area networks, local area networks, metropolitan area networks, and so on;
an image/video capture module 330 (e.g., a camera module) for processing a respective image or video captured by the image/video capture device 324, where the respective image or video may be sent or streamed (e.g., by a client application module 336) to the social network system 108;
an audio input module 332 (e.g., a microphone module) for processing audio captured by the audio input device 320, where the respective audio may be sent or streamed (e.g., by a client application module 336) to the social network system 108;
a location detection module 334 (e.g., a GPS, Wi-Fi, or hybrid positioning module) for determining the location of the client device 300 (e.g., using the location detection device 322) and providing this location information for use in various applications (e.g., social network client module 340); and
one or more client application modules 336, including the following modules (or sets of instructions), or a subset or superset thereof:
   a web browser module 338 (e.g., Internet Explorer or Edge by Microsoft, Firefox by Mozilla, Safari by Apple, or Chrome by Google) for accessing, viewing, and interacting with web sites;
   a social network module 340 for providing an interface to a social networking service (e.g., a social networking service provided by social network system 108) and related features, and for loading (e.g., within the interface for the social network module 340) pages associated with third-party service providers (e.g., to conduct transactions with the third-party service providers); and/or
   optional client application modules 342, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D gaming, virtual reality, electronic book reader, and/or workout support.

In some embodiments, the location detection module 334 may attach a location to an image captured by the client device 300. For example, if a user 102 of the client device 300 captures an image while in San Francisco, Calif., the client device 300 will attach the location to the captured image (e.g., San Francisco, Calif., will be attached).

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

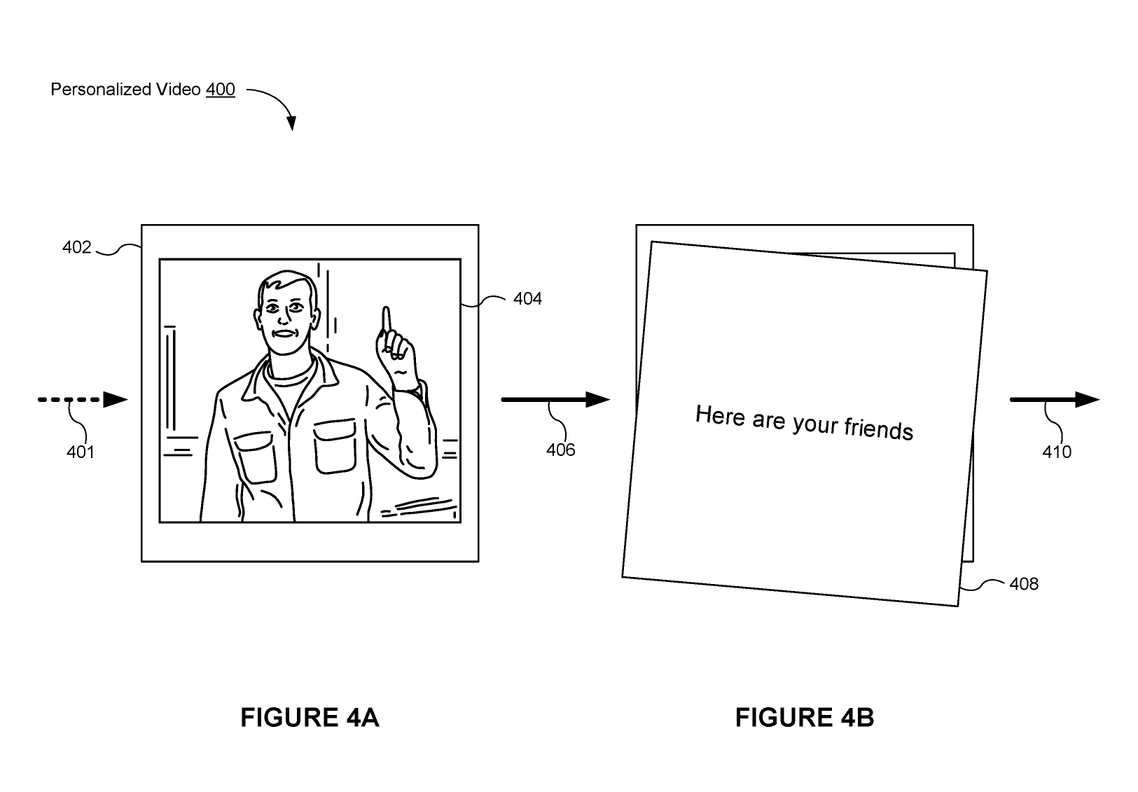

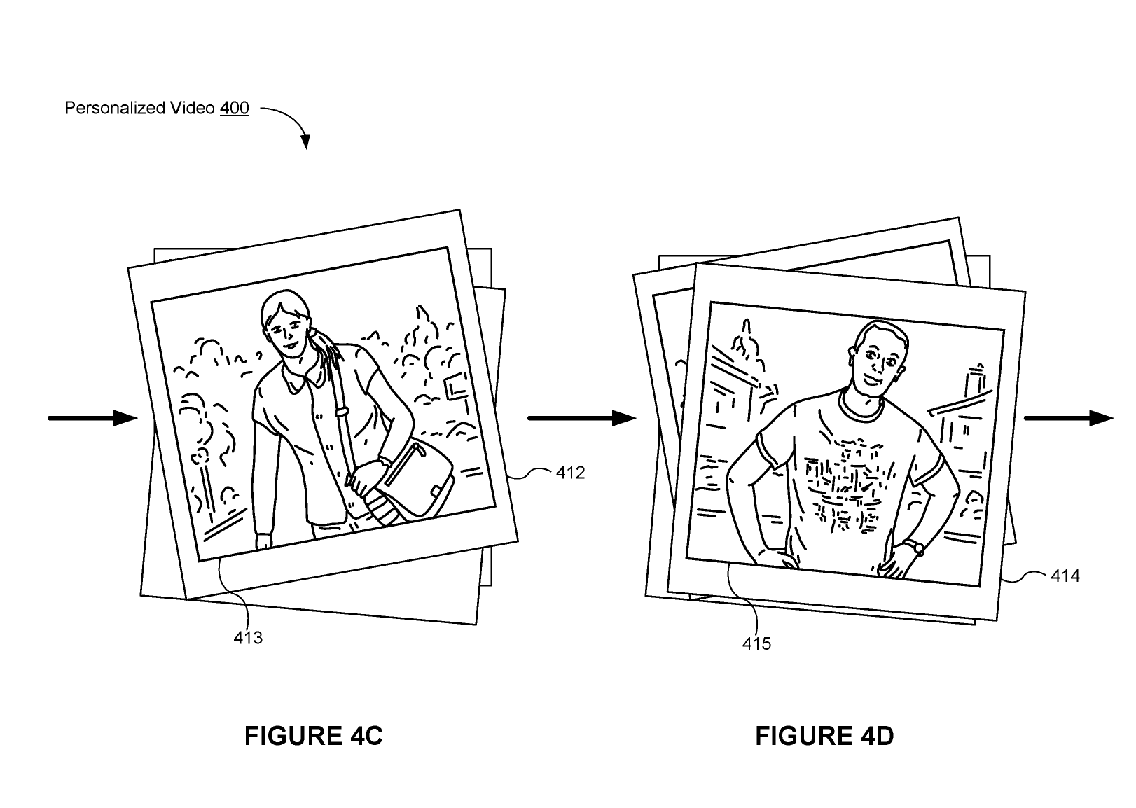

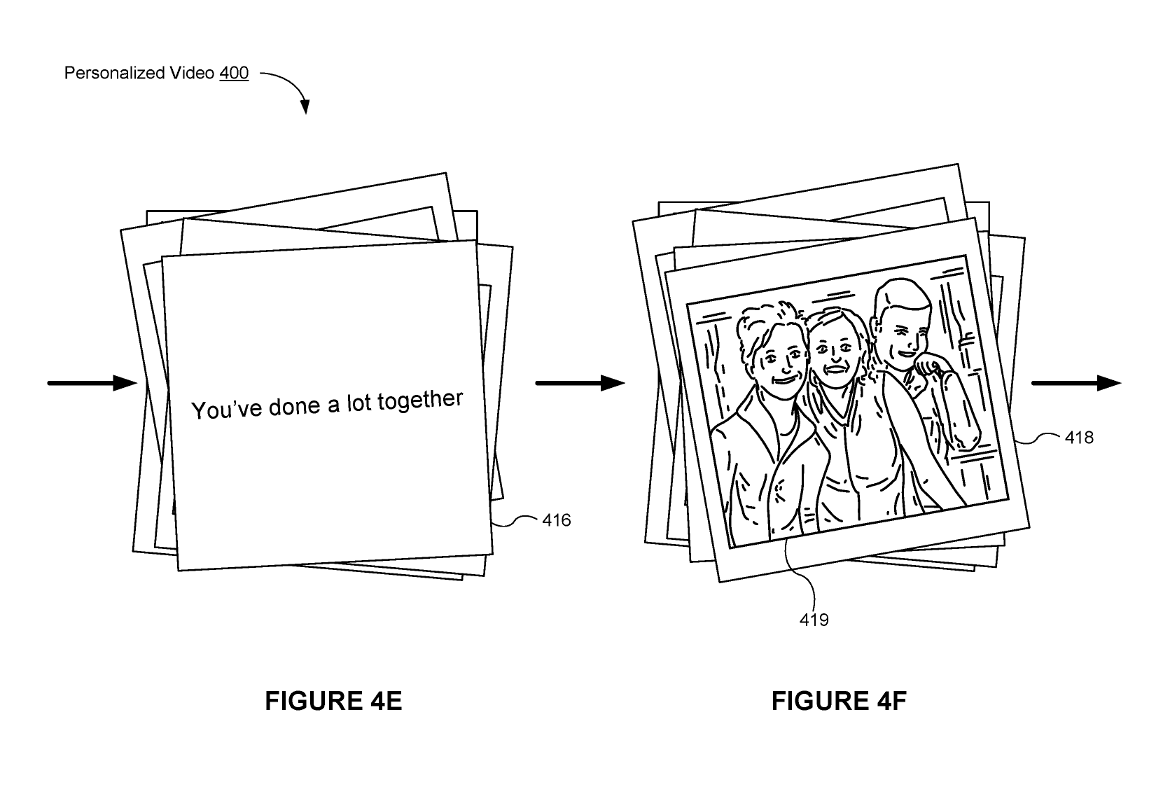

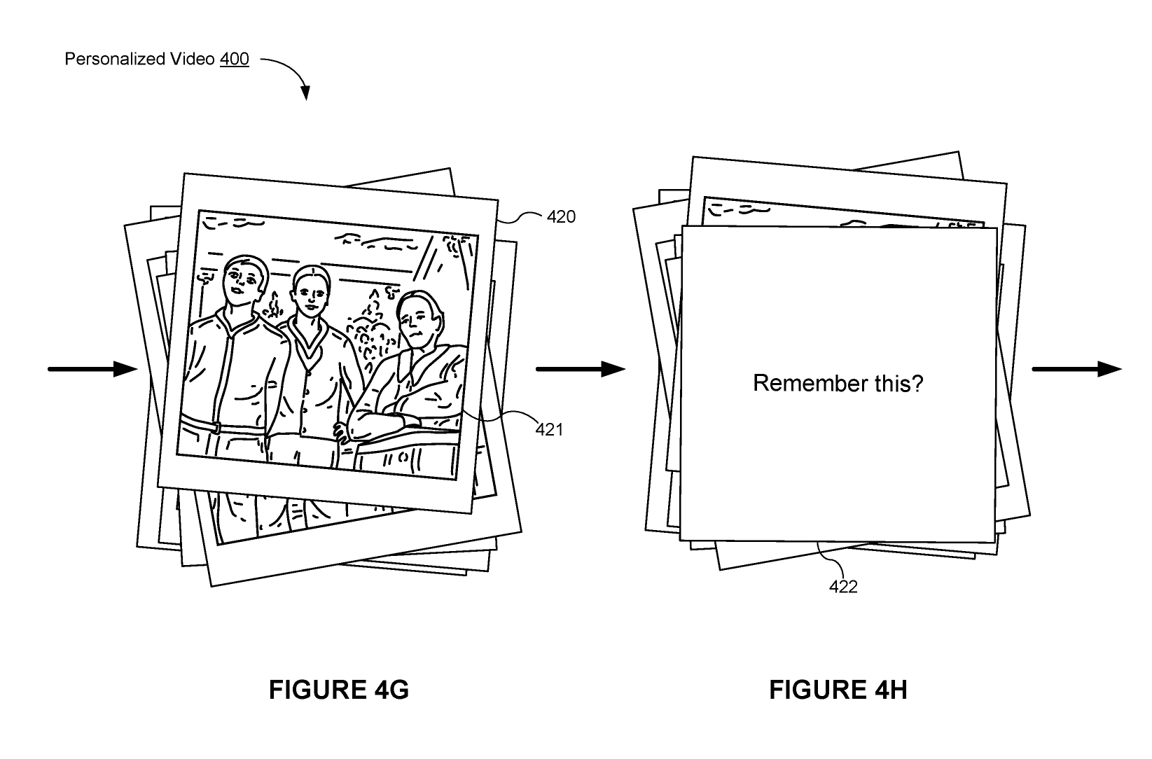

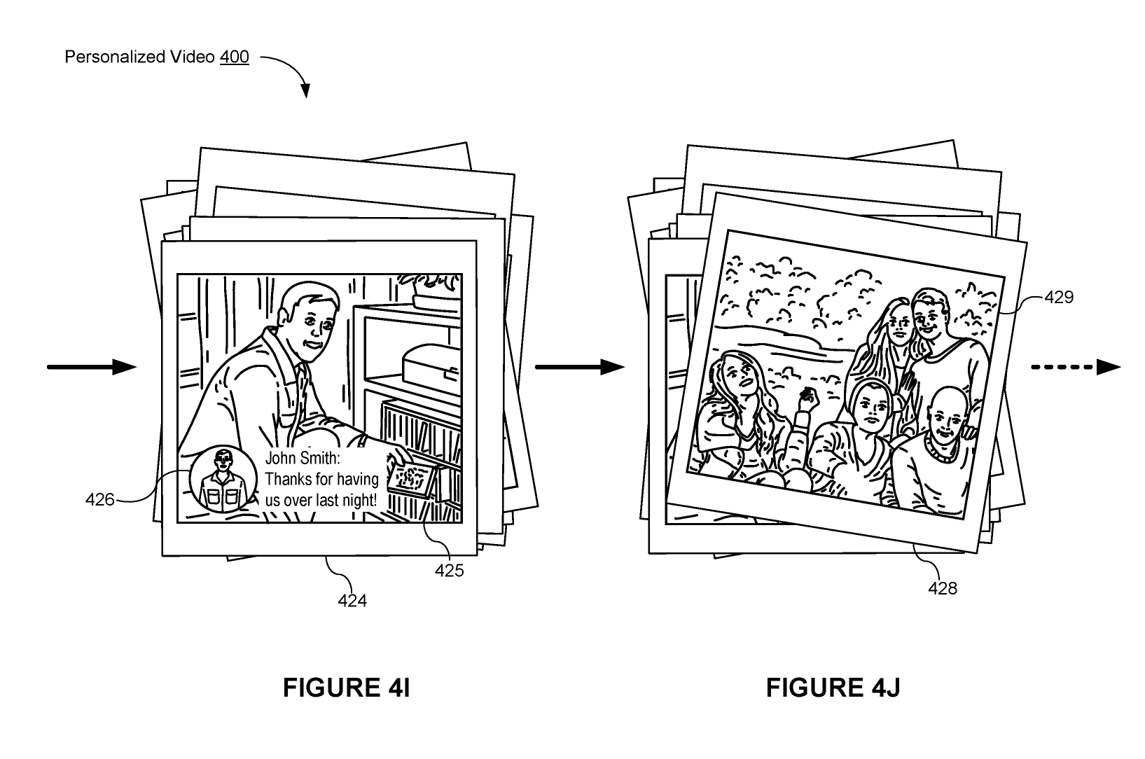

FIGS. 4A-4J illustrate exemplary graphical user interfaces (GUIs) on a client device for presenting a personalized video to a user of a social networking service in accordance with some embodiments. A social networking system (e.g., social network system 108, FIG. 1; server system 200, FIG. 2) may generate and provide the personalized video to the client device. The client device (e.g., client devices 104-1, 104-2, . . . 104-n, FIG. 1) of a user (e.g., users 102-1, 102-2, . . . 102-n, FIG. 1) may display the personalized video 400. Although not shown in FIGS. 4A-4J, the GUIs are displayed on a display (e.g., display 312, FIG. 3) of the client device (e.g., client device 300, FIG. 3). The user, upon logging into the social networking service, may receive a message to view his or her personalized video. In some embodiments, the personalized video is a personalized slideshow video.

A user of the social networking service may participate in the social networking service of the social networking system by providing (e.g., posting) information, such as images (among other things) to the social networking service. For example, a user may post a plurality of images to the social networking service (e.g., contacts of the user) over a period of time. In another example, users of the social networking service may tag and/or otherwise associate the user in a plurality of images over a period of time. Accordingly, the social networking system may store images associated with the user in a social network database (e.g., social network database 214, FIG. 2). Using image recognition software, the social networking system may analyze the stored images associated with the user and may determine which images of the stored images to include in the personalized video. In some embodiments, the social networking system may determine which images to include in the personalized video, at least in part, by determining respective first metrics for the stored images. Alternatively or in addition, the social networking system may determine which images to include in the personalized video, at least in part, by determining respective second metrics for the stored images.

The social networking system may select a set of images to include in the personalized video from the stored images (e.g., profile pictures 242 and other pictures associated with the user 244, FIG. 2). The set of images may also include other images posted by other users of the social networking service (e.g., profile pictures posted by one or more contacts of the user). The social networking system may evaluate a closeness of relationship (also referred to herein as a degree of interaction) between a respective user of the social networking service and the user when selecting these other images for the set of images. In some embodiments, when evaluating the closeness of relationship, the social networking system may evaluate entity information (e.g., entity information 216, FIG. 2) and connection information (e.g., connection information 220, FIG. 2) for the respective user of the social networking service and the user. For example, the social networking system may determine a number of edges connecting the user (e.g., a first node) and the respective user of the social networking service (e.g., a second node). In this way, the social networking system may select images from the stored images associated with close friends of the user (i.e., the personalized video should include images of the user with his or her friends). Edges and nodes are discussed in further detail above with reference to FIG. 2.

In some embodiments, the respective user of the social networking service is a respective contact of the user. In some embodiments, the social networking system may identify a plurality of contacts of the user to include in profile picture slides of the personalized video, in accordance with the discussion above. For example, the social networking system may select between 2 and 5 profile pictures of contacts of the user to include in the profile picture slides.

In some embodiments, the social networking system may store the other images (e.g., profile pictures of contacts of the user) in the stored images associated with the user (user information 218 of the user, FIG. 2). In some embodiments, the social networking system may store the other images in respective social network databases associated with the respective contacts of the plurality of contacts (user information 218 of the respective user of the social networking service). The social networking system, when determining the set of images to include the personalized video, may retrieve the other images from the respective social network databases. Alternatively, in some embodiments, the social networking system stores a location of the other images (e.g., at a third-party server).

After determining the set of images to include in the personalized video, the social networking system may position each image of the set of images at a designated position in the personalized video. The set of images may be equal in number to a number of image slides included in the personalized video. Moreover, the personalized video may include one or more scenes. For example, a first scene may present a profile picture(s) of the user and profile pictures of contacts of the user, while a second scene may present group images of the user with other users of the social networking service (e.g., contacts of the user and the user). FIGS. 4A-4J illustrate the personalized video as it is viewed on a client device (e.g., client device 300, FIG. 3).

FIG. 4A illustrates an initial image slide 402 of a personalized video for a user of the social networking system. The initial slide 402 includes a first image 404 from the set of images. In some embodiments, the first image 404 may be a profile picture of the user. A profile picture is an image (e.g., selected by the user) used to identify the user while participating on the social networking service (e.g., the image may be displayed in a header portion of the user's account page). The profile picture may be displayed with interactions (e.g., each interaction) on the social networking service by the user (e.g., the image may be displayed as part of a post made by the user). In some embodiments, the first image 404 for the initial slide 402 is a current profile picture of the user. However, in some circumstances, the current profile picture of the user may not satisfy criteria for the first image slide 402 (e.g., the profile picture may be of a landscape, such as mountains). In these circumstances, the first image 404 may be a previously posted profile picture of the user (e.g., the social networking system, when determining the set of images to include in the personalized video, may analyze each profile picture of the user posted over a period time and may select one of the profile pictures that satisfies the criteria for the first image slide 402). In some embodiments, the first image 404 may be an image posted by another user of the social networking service in which the user is tagged (e.g., the other user identified the user in the image or image recognition software identified the user in the image). For example, the first image 404 may be a portrait photograph of the user posted by another user of the social networking service.

In some embodiments, the initial image slide 402 is presented subsequent to one or more text slides. For example, a first text slide may identify the user of the social networking service (e.g., user is named Jeffrey, the first text slide may state “Hi Jeffrey”).

During presentation of the personalized video on the client device, subsequent slides may be placed on top of previous slides (e.g., text slide 408 overlays the initial slide 402). As such, arrows (e.g., arrow 406) represent points in time when a new slide is added in the personalized video. In some embodiments, the personalized video may depict a person (e.g., a person's hand) placing a subsequent slide on top of a previous slide (not shown). Subsequent slides may be placed at different orientations from previous slides. In this way, the slides appear to form a stack of slides during the video. One skilled in the art will appreciate that various presentations methods may be used (e.g., a book having each slide on a page or simply display of the respective slides individually).

FIG. 4B illustrates a text slide 408 that may separate the initial slide 402 from subsequent slides. In some embodiments, text on the text slide 408 is associated with a subsequent image slide and/or the next scene in the personalized video. For example, the text slide 408 may state “Here are your friends” and a subsequent image slide may be an image of a friend (e.g., a contact) of the user. Moreover, the next scene in the personalized video may be profile pictures of contacts of the user.

FIGS. 4C-4D illustrate profile picture image slides of respective contacts the user. FIG. 4C illustrates a first profile picture slide 412 of a first contact of the user. In some embodiments, the first profile picture slide 412 includes a second image 413 from the set of images. The social networking system may select the first contact from the plurality of selected contacts. Furthermore, in some embodiments, the first contact may be selected at random from the plurality of selected contacts. Alternatively, in some embodiments, the first contact may be selected in accordance with a determination that the first contact is the closest contact of the user (by evaluating connection information and entity information as discussed above).

In some embodiments, the second image 413 is a current profile picture of the first contact. However, in some circumstances, the current profile picture of the first contact may not satisfy criteria for the second image slide 412 (e.g., the profile picture may be of a landscape such as mountains). In these circumstances, the second image 413 may be a previously posted profile picture of the first contact (e.g., the social networking system, when determining the set of images to include in the personalized video, may analyze each profile picture of the first contact posted over a period time and may select one of the previously posted profile pictures that satisfies the criteria for the first image slide 412).

FIG. 4D illustrates a second profile picture slide 414 of a second contact of the user. The second profile picture slide 414 includes a third image 415 from the set of images. The social networking system may select the second contact from the plurality of selected contacts. Furthermore, in some embodiments, the second contact may be selected at random from the plurality of selected contacts. Alternatively, in some embodiments, the second contact may be selected in accordance with a determination that the second contact is the second closest contact of the user (by evaluating connection information and entity information as discussed above) or is otherwise related to scene of the personalized video.

In some embodiments, the third image 415 is a current profile picture of the second contact. However, in some circumstances, the current profile picture of the second contact may not satisfy criteria for the third image slide 414 (e.g., the profile picture may be of a landscape such as mountains). In these circumstances, the third image 415 may be a previously posted profile picture of the second contact (e.g., the social networking system, when determining the set of images to include in the personalized video, may analyze each profile picture of the second contact posted over a period time and may select one of the previously posted profile pictures that satisfies the criteria for the second image slide 414).

In some embodiments, although not shown, the personalized video 400 may include one or more additional profile picture slides after the profile picture slide 414. The one or more images included in the additional profile picture slides may be selected in accordance with the discussion above. Furthermore, the criteria discussed above with reference to the first, second, and third image slides may be based, at least in part, on first metrics and/or second metrics. The first and second metrics are discussed in further detail below with reference to FIG. 5.

FIG. 4E illustrates a text slide 416 that may separate the profile picture slides (e.g., slides 412 and 414) from subsequent image slides. In some embodiments, text on the text slide 416 is associated with a subsequent image slide and/or the next scene in the personalized video. For example, the text slide 416 may state “You've done a lot together” and the subsequent image slide may be an image of one or more friends (e.g., contacts) with the user. Moreover, the next scene in the personalized video may be for group photos.

FIGS. 4F-4G illustrate group picture slides of users of the social networking service and the user. In some embodiments, the users of the social networking service are contacts of the user. The social networking system may evaluate a closeness of relationship between the users of the social networking service and the user when selecting the images for the set of images. For example, the social networking system may determine a number of edges connecting the user (e.g., a first node) and a respective user of the social networking service (e.g., a second node). In this way, the social networking system may determine which users of the social networking service have a relationship with the user (i.e., the personalized video should include images of close friends of the user).

FIG. 4F illustrates a first group picture slide 418 of a first group picture. The first group picture slide 418 includes a fourth image 419 from the set of images. In some embodiments, the social networking system, when determining the set of images to include in the personalized video, may analyze a plurality of group photos in the stored images of the user and may select one of the group photos that satisfies a criteria for the first group picture slide 418. In some embodiments, the fourth image 419 includes at least a plurality of people in the image (e.g., the user and at least one other user of the social networking service). Furthermore, the fourth image 419 may have a limited number of people in the image (e.g., the user and no more than three other users of the social networking service).

FIG. 4G illustrates a second group picture slide 420 of a second group picture. The second group picture slide 420 includes a fifth image 421 from the set of images. In some embodiments, the social networking system, when determining the set of images to include in the personalized video, may analyze the plurality of group photos in the stored images of the user and may select one of the group photos that satisfies a criteria for the second group picture slide 420. In some embodiments, the fifth image 421 includes at least a plurality of people in the image (e.g., the user and at least one other user of the social networking service). Furthermore, the fifth image 421 may have a limited number of people in the image (e.g., the user and no more than three other users of the social networking service). In some embodiments, the fourth image 419 and the fifth image 421 have a different number of people in the respective images. In some embodiments, the fourth image 419 and the fifth image 421 have different users of the social networking service in the respective images.

The criteria discussed above with reference to the first and second group picture slides may be based, at least in part, on first metrics and/or second metrics. The first and second metrics are discussed in further detail below with reference to FIG. 5.

FIG. 4H illustrates a text slide 422 that may separate the group picture slides (e.g., slides 416 and 418) from subsequent slides. In some embodiments, text on the text slide 422 may be associated with a subsequent image slide and/or the next scene in the personalized video. For example, the text slide 422 may state “Remember this?” and the subsequent image slide may be an image of a memory of the user. Moreover, the next scene in the personalized video may be for images of various memories of the user.

FIG. 4I illustrates a memory image slide 424 of a memory image associated with the user. The memory slide 424 may include a sixth image 425 from the set of images. The social networking system may designate an image as a memory image when an image satisfies neither criteria for profile pictures or group images. In some embodiments, the social networking system may designate an image as a memory image based on one or more factors. The one or more factors may include a location associated with the image. For example, a locational tag associated with the image may signal to the social networking system that the image was taken (e.g., captured) away from the user's home (i.e., the image was taken on a trip or an outing). The one or more factors may include an image type. For example, a scenic image (e.g., a landscape of mountains) may signal to the social networking system that the image was taken on a trip or on an outing (e.g., during a hike). The one or more factors may include feedback for an image. For example, the social networking system may designate an image as a memory based on a comment on the image by another user of the social networking service (e.g., an image of a dinner party at the user's home with a comment saying “Thanks for having us over last night!”).

In some embodiments, the social networking system may overlay information 426 associated with the sixth image 425 on the memory image slide 424. For example, the social networking system may overlay one or more comments associated with the sixth image 425 (e.g., comment stating “Thanks for having us over last night!”). Moreover, the information 426 may include an identifier of the person who provided the comment. For example, the information 426 may include an account identity of the user of the social networking service who provided the comment (e.g., John Smith). Furthermore, the information 426 may include a profile picture of the user of the social networking service (e.g., a profile picture for John Smith).

FIG. 4J illustrates a group picture slide 428 of a final group picture. The group picture slide 428 may include a seventh image 429 from the set of images. In some embodiments, seventh image 429 is positioned at a designated position in the personalized video (e.g., at a final image slide in the personalized video). In some embodiments, the seventh image 427 has a threshold number of people in the photo (e.g., the threshold number of people may be at least five users of the social networking service, including the user).

Although the selected images (e.g., profile picture 404, first profile picture 413, etc.) are shown with a white border, other forms of image slides may be included in the personalized video. For example, the image slides may not have a border surrounding the selected images. In another example, one or more of the image slides may include a video or a 360° virtual reality image posted by the user and/or other users (e.g., a video of the user with a plurality of contacts of the user). In addition, the group picture slide 428 may be followed by one or more additional slides (e.g., one or more text slides and/or other image slides).

FIGS. 5A-5D are flow diagrams illustrating a method 500 of generating a personalized video for a user of a social networking service in accordance with some embodiments. The steps of the method 500 may be performed by any combination of client device (e.g., a client device 104, FIG. 1; client device 300, FIG. 3) and/or social networking system (e.g., social network system 108, FIG. 1; server system 200, FIG. 2). FIGS. 5A-5D correspond to instructions stored in a computer memory or computer readable storage medium (e.g., memory 206 of the server system 200; memory 306 of the client device 300). For example, the operations of method 500 are performed, at least in part, by a social network server module (e.g., social network server module 226, FIG. 2) and/or client application modules (e.g., client application modules 336, FIG. 3).

In performing the method 500, the social networking system may generate (502) a personalized video for a user of a social networking service. The social networking system, for a plurality of images associated with the user, may determine respective metrics (e.g., first metrics and/or second metrics) for respective images of the plurality of images. In some embodiments, the social networking system stores the plurality of images associated with the user (e.g., stores the images in social network database 214, FIG. 2). A user of the social networking service provided by the social networking system may provide (e.g., post) the plurality of images to the social networking service. Alternatively or in addition, other users of the social networking service may provide one or more images for the plurality of images. Providing and storing the plurality of images is discussed in further detail with reference to FIGS. 4A-4J above.

In some embodiments, the social networking system may (504) determine respective first metrics for respective images of the plurality of images based on one or more predefined image-content criteria. In some embodiments, the social networking system may determine the first metrics for the respective images of the plurality of images using image recognition software. In some embodiments, the image recognition software may be part of a third-party server. In some embodiments, the image recognition software may be part of the social networking system (e.g., image analyzing module 224, FIG. 2). Those skilled in the art will appreciate that various image recognition programs may be used to analyze the plurality of images.

In some embodiments, the one or more predefined image-content criteria (506) comprise at least one of whether an image includes people and a portion of an image occupied by one or more people. For example, the one or more predefined image-content criteria may favor images from the plurality of images having people. Moreover, the one or more predefined image-content criteria may favor images having people who are recognizable in the images. In some embodiments, the one or more predefined image-content criteria include whether an image includes an animal (e.g., a pet such as a cat or dog). In some embodiments, the one or more predefined image-content criteria include whether an image includes an infant. The social networking system may favor, for at least some of the plurality of images, images having a single person (e.g., profile pictures having a single person in the image). The social networking system may favor, for at least some other of the plurality of images, images having a plurality of people (e.g., group photos). For example, images having between two and four people may be favored. In another example, images having at least five people may be favored.

In some embodiments, the one or more predefined image-content criteria (508) comprise a degree to which a subject of an image is obstructed. As used herein, a subject may be a user of the social networking service, non-users of the social networking service, an infant, and/or an animal such as a cat or a dog. The one or more predefined image-content criteria may favor images that lack obstructions of the subject(s) of the image. For example, the social networking system may not favor an image of a contact of the user that is partially obstructed by an object or another person. As such, respective first metrics for obstructed images may be modified (e.g., reduced) in accordance with a degree of obstruction.

In some embodiments, the one or more predefined image-content criteria (510) comprise a criterion favoring photographs over synthetic images. A synthetic image may be an image that is computer generated as opposed to an image that is captured by a camera (e.g., captured by an image capture device 324 of the client device 300, FIG. 3). A photograph is an example of an image. As such, respective first metrics for synthetic images may be modified (e.g., reduced) by a predetermined amount (e.g., degree).

In some embodiments, the one or more predefined image-content criteria (512) comprise whether an image is a portrait. A portrait may be a photograph with a subject that satisfies (e.g., fills) a first threshold percentage of the photograph but does not exceed (e.g., fill) a second threshold percentage (e.g., a close-up image of the subject). In some embodiments, the first and second threshold percentages may vary depending on a number of subjects in the photograph. For example, an image may be deemed a portrait when the image includes say, for example, two subjects. In such a situation, the threshold percentages are decreased accordingly. In some embodiments, the social networking system may favor, for at least some other of the plurality of images, portrait images (e.g., profile pictures that are portraits of the subject may be favored for a particular scene). In some embodiments, the social networking system may not favor portrait images for at least some other of the plurality of images.

In some embodiments, the one or more predefined image-content criteria may comprise whether an image includes one or more users of the social networking service. For example, the one or more predefined image-content criteria may favor images having users of the social networking service (e.g., a user may be tagged (i.e., identified) in the image either by a user of the social networking service and/or by the recognition software). As such, respective first metrics for images with one or more users of the social networking service may be modified (e.g., increased) by a first predetermined amount. Furthermore, the one or more predefined image-content criteria may comprise whether an image includes one or more contacts of the user. For example, the one or more predefined image-content criteria may favor an image with one or more contacts of the user over images with users of the social networking service. As such, respective first metrics for images with one or more contacts of the user may be modified (e.g., increased) by a second amount. In some embodiments, the second amount may be greater than the first amount. The first and second amounts may be predetermined amounts.

In some embodiments, the one or more predefined image-content criteria may comprise whether an image satisfies general image quality criteria. For example, the one or more predefined image-content criteria may favor images that are in focus, are properly exposed, and use a film speed that satisfies a threshold film speed.

In some embodiments, when determining the first metrics for the plurality of images, the social networking system may use one or more coefficients (e.g., coefficients a and b) to weight (e.g., increase, normalize, or reduce) a respective predefined image-content criterion of the one or more predefined image-content criteria associated with the first metric. For example, the social networking system may favor images that are portraits. As such, the social networking system may modify (e.g., using coefficient a) the first metric for each portrait image to increase a probability of a portrait image being selected. In another example, the social networking system may disfavor images that are landscapes. In this example, the social networking system may modify (e.g., using coefficient b) the first metric for each landscape image to reduce a probability of a landscape image being selected.

In some embodiments, the one or more coefficients may be scene specific. In some embodiments, the social networking system may weight one or more of the predefined image-content criteria in selecting images for certain scenes. For example, the social networking system may favor certain of the image-content criteria when selecting, say, profile pictures. Using this example, the social networking system may modify (e.g., using coefficient a) the first metric for each portrait image to increase a probability of a portrait image being selected in a profile picture scene of the personalized video.

In some embodiments, the social networking system may determine (514) respective second metrics for the respective images of the plurality of images based on feedback for the respective images provided by users of the social networking service. In some embodiments, the feedback for determining the second metrics may include one or more feedback criteria. In some embodiments, the one or more feedback criteria include likes, comments, and shares of the respective images by users of the social networking service (516). For example, a first image of the plurality of images may be selected over a second image over the plurality of images when the first image includes likes, comments, and/or shares and the second image does not (or the second image has a smaller number of likes, comments, and/or shares relative to the first image). In some embodiments, the social networking system may select at least one image for the first set of images having one or more comments.

In some embodiments, the one or more feedback criteria may include a degree of interaction between the user and other users of the social networking service providing feedback on the respective image (516). The degree of interaction may be related to a number of likes, comments, shares, and/or personal messages between the user and another user of the social networking service. Alternatively or in addition, the degree of interaction may include whether the user and a respective other user of the social networking service are contacts (i.e., friends on the social networking service). Evaluating closeness of relationships between contacts of the user and the user is discussed in further detail above with reference to FIGS. 2 and 4 (e.g., discussion of edges and nodes).

In some embodiments, when determining the second metrics for the plurality of images, the social networking system may use one or more coefficients (e.g., coefficients c and d) to weight (e.g., increase, normalize, or reduce) a respective feedback criterion of the one or more feedback criteria. For example, the social networking system may favor likes, comments, and/or shares from contacts of the user (as opposed to comments, likes, and/or shares from non-contacts of the user). As such, the social networking system may modify (e.g., using coefficient c) the second metric for each image of the plurality of images having comments, likes, and/or shares from contacts of the user to increase the probability of those images being selected. In another example, the social networking system may favor images showing close contacts (e.g., close friends) of user as opposed to non-close contacts of the user. Closeness may be determined, for example, based on degrees of interaction (e.g., amounts and/or frequencies of comments, likes, shares, messages, tagging in posts, etc.) between users, numbers of contacts in common, common interests, common backgrounds (e.g., school, employment), and the like. In this example, the social networking system may modify (e.g., using coefficient d) the second metric for each image of the plurality of images associated with close-contacts of the user to increase a probability of those images being selected. Evaluating closeness of relationships between contacts of the user and the user is discussed in further detail above with reference to FIGS. 2 and 4 (e.g., discussion of edges and nodes).

In some embodiments, the social networking system may specify (518) a number of image slots (e.g., slides) available in the personalized video. Furthermore, the social networking system may specify a number of images in the first set of images that equals the number of image slots available in the personalized video. Furthermore, the social networking system may generate one or more text slides associated with scenes of the personalized video. For example, the social networking system may intersperse one or more text slides with the first set of images in the personalized video. The social networking system may specify the number of image slides available in the personalized video before generating the personalized video.

In performing the method 500, the social networking system may select (520) a first set of images from the plurality of images based at least in part on the respective first metrics. In some embodiments, the first set of images may include a first subset of images designated for a first scene in the personalized video, a second subset of images designated for a second scene in the personalized video, a third subset of images designated for a third scene in the personalized video, and so on. The first subset of images in the personalized video may include profile pictures. The second subset of images may include group photos not exceeding a threshold number of subjects in the images (or may include group photos that exceed a threshold number of subjects in the images). The third subset of images may include photos that are designated as memories. It should be noted that the scenes may be ordered in various sequences by the social networking system.

In some embodiments, the social networking system, when selecting the first set of images from the plurality of images, may select (522) a profile picture of the user. In some embodiments, the profile picture is a current profile picture of the user (e.g., the profile picture currently representing the account of the user on the social networking service). In some circumstances, the user may have provided (e.g., posted) a plurality of profile pictures over a period of time (e.g., a year). In these circumstances, the social networking system may determine respective metrics (e.g., first and/or second metrics) for the plurality of profile pictures and may select a respective profile picture of the plurality of profile pictures based, at least in part, on the respective metrics (i.e., the user's current profile picture may not, in some circumstances, be chosen by default). In some embodiments, the profile picture of the user may be selected in accordance with the determined metrics (e.g., first and/or second metrics).

Furthermore, in some embodiments, the social networking system, when selecting the first set of images from the plurality of images, may select (524) one or more profile pictures of contacts of the user. In some embodiments, the one or more profile pictures of contacts of the user are respective current profile pictures of the contacts of the user. In some circumstances, a respective contact of the user may have provided (e.g., posted) a plurality of profile pictures over a period of time. In these circumstances, the social networking system may determine respective metrics (e.g., first and/or second metrics) for the plurality of profile pictures and may select a respective profile picture of the plurality of profile pictures based, at least in part, on the respective metrics (i.e., the respective contact's current profile picture may not, in some circumstances, be chosen by default). In some embodiments, the one or more profile pictures of the contacts of the user are selected in accordance with the determined metrics (e.g., first and/or second metrics).

In some embodiments, the first set of images may include one or more profile pictures of the user and one or more profile pictures of contacts of the user. In some embodiments, the profile picture of the user and/or the one or more profile pictures of the contacts of the user may be part of a first scene of the personalized video. For example, the first scene of the personalized video may include a profile picture of the user and one or more profile pictures of contacts of the user.

In some embodiments, the social networking system, when selecting the first set of images from the plurality of images, may select (526) an image showing one or more contacts of the user (or may select an image showing one or more users of the social networking service). For example, the one or more contacts may have been tagged in the image or identified in the image by image analysis software. In response to selecting an image showing one or more contacts of the user, the social networking system may modify (528) the first metric for another image showing any of the one or more contacts to reduce a probability of the other image showing the one or more contacts being selected. In some embodiments, the social networking system may modify the first metric for another image sharing the same image type as the image (i.e., the social networking system may modify first metrics by scene). For example, the social networking system may reduce the first metric for other profile pictures showing any of the one or more contacts of the user when the selected image is also a profile picture. In some embodiments, the social networking system may flag the one or more identified contacts (e.g., the social networking system may flag an account associated with the user). In response to flagging the account of the user, the social networking system may not select another image showing the same account. In some embodiments, the flagging is limited to particular scenes (e.g., profile picture scene). In some embodiments, the social networking system may modify (e.g., reduce) the first metric for another image showing any of the one or more contacts by a third amount, which may be a predetermined amount. In some embodiments, the third amount may be greater than the first and second amounts (the first and second amounts are discussed above).

In some embodiments, the social networking system, when selecting the first set of images from the plurality of images, may select (530) an image showing a location. For example, the image may have a location tag associated with the image (e.g., a client device (e.g., client device 300, FIG. 3) may attach GPS coordinates to an image captured by the client device). In this way, the social networking system (or the client device) may associate the GPS coordinates with a location (e.g., Lake Tahoe, Calif., USA). In some embodiments, the social networking system may expand a scope of the location by an amount. For example, if the location is Lake Tahoe, then the social networking system may expand the scope to incorporate other areas surrounding Lake Tahoe. The amount of expansion may vary depending on the location (e.g., rural areas may have a greater expansion relative to expansion in urban areas, or vice versa).

In response to selecting an image showing a location, the social networking system may modify (532) the first metric for another image showing the location to reduce a probability of the other image showing the location being selected. For example, the social networking system may modify (e.g., reduce) a first metric for other images taken in the location. To continue the example from above, the social networking system may flag other images associated with the user taken in Lake Tahoe, Calif. The social networking system may modify first metrics for other images taken in the location (and the surrounding areas) so that the personalized video shows images from various locations. In some embodiments, the social networking system may modify (e.g., reduce) the first metric for other images taken in the location by a fourth amount, which may be a predetermined amount.

In some embodiments, the social networking system, when selecting the first set of images from the plurality of images, may select (534) a first image having a first timestamp falling within a first period of time. For example, the social networking system may select one or more images that were taken (e.g., captured) during the first period of time. The period of time may be, for example, over a holiday weekend or a week during a given month of the year.

In response to selecting the first image having the first timestamp falling within the first period of time, the social networking system may modify (536) the first metric for a second image having a second timestamp falling within the first period of time to reduce a probability of the second image being selected. In some embodiments, the social networking system may modify (e.g., reduce) the first metric for the second image having the second timestamp falling within the first period of time by a fifth amount, which may be a predetermined amount.

In some embodiments, the social networking system may modify the first metric for a third image having a third timestamp falling within a second period of time to reduce a probability of the second image being selected. In some embodiments, the second period of time is a period of time near the first period of time. For example, if the first period of time is a week during the middle of January, 2015, then the second period of time may be the other weeks in January 2015. In some embodiments, the social networking system may reduce the first metric for the second image by a first amount and may reduce the first metric for the third image by a second amount (e.g., the first amount may be greater than the second amount).

In some embodiments, the social networking system, when selecting the first set of images from the plurality of images, may select an image showing a location and one or more contacts of the user (and/or a first timestamp in a first period of time). In response to selecting an image showing a location and having the one or more contacts of the user, the social networking system may modify the first metric for another image showing the location and any of the one or more contacts to reduce a probability of the other image showing the location and the one or more contacts being selected. In some embodiments, the social networking system may modify (e.g., reduce) the first metric by a sixth amount, which may be a predetermined amount. The sixth amount may be greater than the first, second, third, fourth, and fifth amounts.

In some embodiments, the social networking system may select (538) the first set of images based further, at least in part, on the second metrics. For example, the social networking system may consider the second metrics as an alternative to or in addition to the first metrics when selecting the first set of images for the personalized video. Furthermore, the social networking system, when selecting the first set of images, may rank (540) the plurality of images using the respective first metrics and/or the respective second metrics. Moreover, the social networking system may form a respective subset of images designated for a respective scene in the personalized video from the plurality of images (e.g., the respective subset of images may be profile pictures). Thereafter, the social networking system may rank the respective subset of images using the respective first metrics and/or the respective second metrics.

Additionally, the social networking system may choose (542) images for the first set of images from the plurality of images in accordance with the ranking. For example, the social networking system may choose, say, ten images having the highest rank for the personalized video. In circumstances where the social networking system formed the respective subset of images (or multiple respective subsets of images), the social networking system may choose images for the first subset of images from the plurality of images in accordance with the ranking of the respective subset of images.

In some embodiments, the social networking system, when selecting the first set of images, may select (544) at least one image having one or more comments. For example, the social networking system may select a first image (e.g., an image of the user on vacation in location X) over a second image (e.g., another image of the user on vacation in location X) when the first image includes one or more comments from contacts of the user (or simply other users of the social networking service). In some embodiments, the social networking system may select an image with two or more comments.

In some embodiments, the social networking system may overlay at least one of the one or more comments on the selected image (step 556). For example, the social networking system may overlay the at least one comment on a portion of the selected image (e.g., information 426, FIG. 4I). In some embodiments, the social networking system may overlay the at least one comment on a first portion of the selected image, and subsequently translate the at least one comment to a second portion of the selected image while the selected image is displayed in the personalized video. In circumstances where the social networking system selects an image with two or more comments, the social networking system may overlay a first comment of the two or more comments in a first portion of the selected image and may overlay a second comment of the two or more comments in a second portion of the selected image. Alternatively, the social networking system may overlay the first comment in a first portion of the selected image, subsequently translate the first comment to a second portion of the selected image (or translate the first comment such that is disappears during the video), and may overlay the second comment in the first portion of the selected image. This process may be repeated if the image includes three or more comments.

In some embodiments, the social networking system may analyze a comment prior to overlaying the comment on the image. For example, when an image includes, say, five comments, the social networking system may analyze the comments to determine the relevance of each comment to the image. Moreover, the social networking system may not overlay one or more comments of the five comments associated with an image based on content of the one or more comments.

In some embodiments, when selecting the first set of images, the social networking system may select a plurality of group images that each comprises the user and a plurality of other users of the social networking service. In some embodiments, the plurality of other users of the social networking service includes one or more contacts of the user. In some embodiments, the plurality of group images may be part of a second scene of the personalized video.

In some embodiments, when selecting the first set of images, the social networking system may select (546) a group image that comprises the user and a plurality of other users of the social networking service. In some embodiments, the group image differs in some respect from the plurality of selected group images (e.g., fewer subjects in the plurality of selected group images). In some embodiments, the plurality of other users of the social networking service includes one or more contacts of the user. In some embodiments, the group image includes a mixture of other users of the social networking service and contacts of the user.

In some embodiments, the social networking system may select (548) images from the first set of images showing respective numbers of people below a threshold number of people. In some embodiments, the selected images showing the respective numbers of people below the threshold number of people are part of a first group scene in the personalized video. For example, the social networking system may select images having less than four subjects in the images.

In performing the method 500, the social networking system may populate (550) the personalized video with the first set of images. As discussed above, the social networking system may select the profile picture of the user when selecting the first set of images. Furthermore, in some embodiments, the social networking system may include (552) the profile picture of the user as an initial image slide in the personalized video when populating the personalized video with the first set of images.

As discussed above, the social networking system may select one or more profile pictures of contacts of the user. Furthermore, in some embodiments, the social networking system may include (554) the one or more profile pictures of the contacts of the user in image slides following the initial image slide in the personalized video. In some embodiments, the first set of images may include a first subset of images designated for a first scene in the personalized video. In some embodiments, the first scene is a profile picture scene (e.g., the social networking system may populate the first scene with the profile picture of the user as an initial image slide and may also populate the first scene with the one or more profile pictures of the contacts of the user in image slides following the initial image slide).

In some embodiments, populating the personalized video comprises including the plurality of group images that each comprises the user and the plurality of other users of the social networking service.

In some embodiments, populating the personalized video comprises including the group image in a slide at a designated position in the personalized video (558). In some embodiments, the slide at the designated position is a final image slide in the personalized video (560). Furthermore, in some embodiments, the social networking system sets a threshold number of users (and/or contacts of the users) required for the group image at the designated position. Consequently, in accordance with a determination that the group image does not satisfy the threshold, the social networking system may select another group image when selecting the first set of images. Alternatively, in accordance with a determination that the group image satisfies the threshold, the social networking system populates the slide at the designated position with the group image. In some embodiments, the threshold is at least four other users of the social networking service (and/or contacts of the user) (562).

In performing the method 500, the social networking system may provide (564) the personalized video to the user for viewing. For example, the social networking system may provide the personalized video to a client device (e.g., client device 300, FIG. 3) associated with the user of the social networking service. The personalized video may be displayed on a display of the client device. In some embodiments, the social networking system provides the personalized video at a specified time and/or date (e.g., on an anniversary). In some embodiments, the social networking system may provide the personalized video to the user in response to receiving a request.

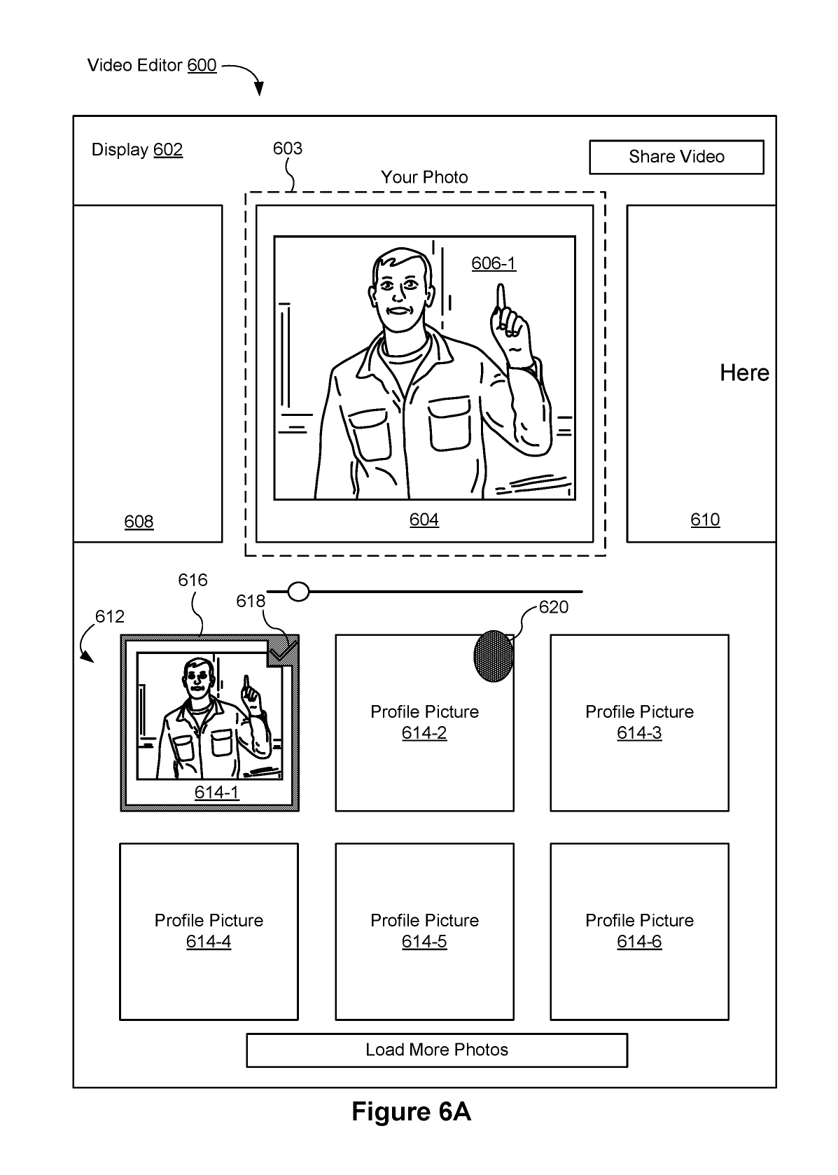

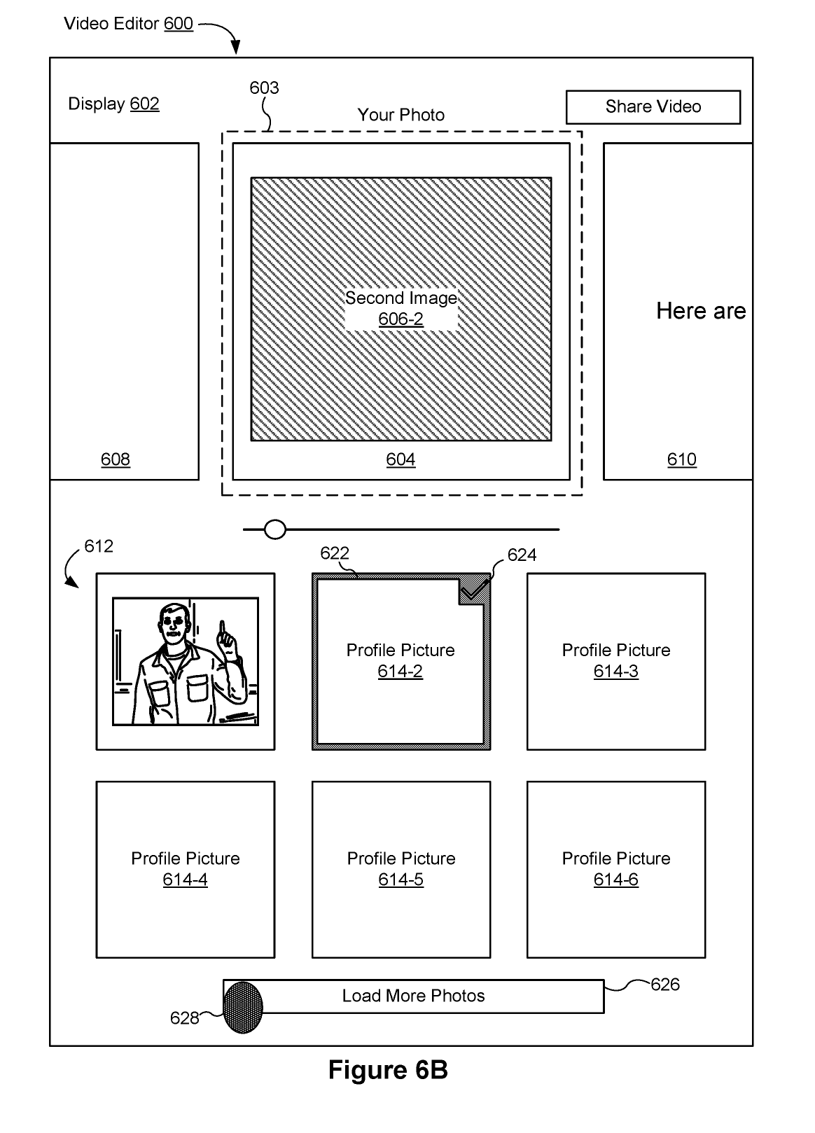

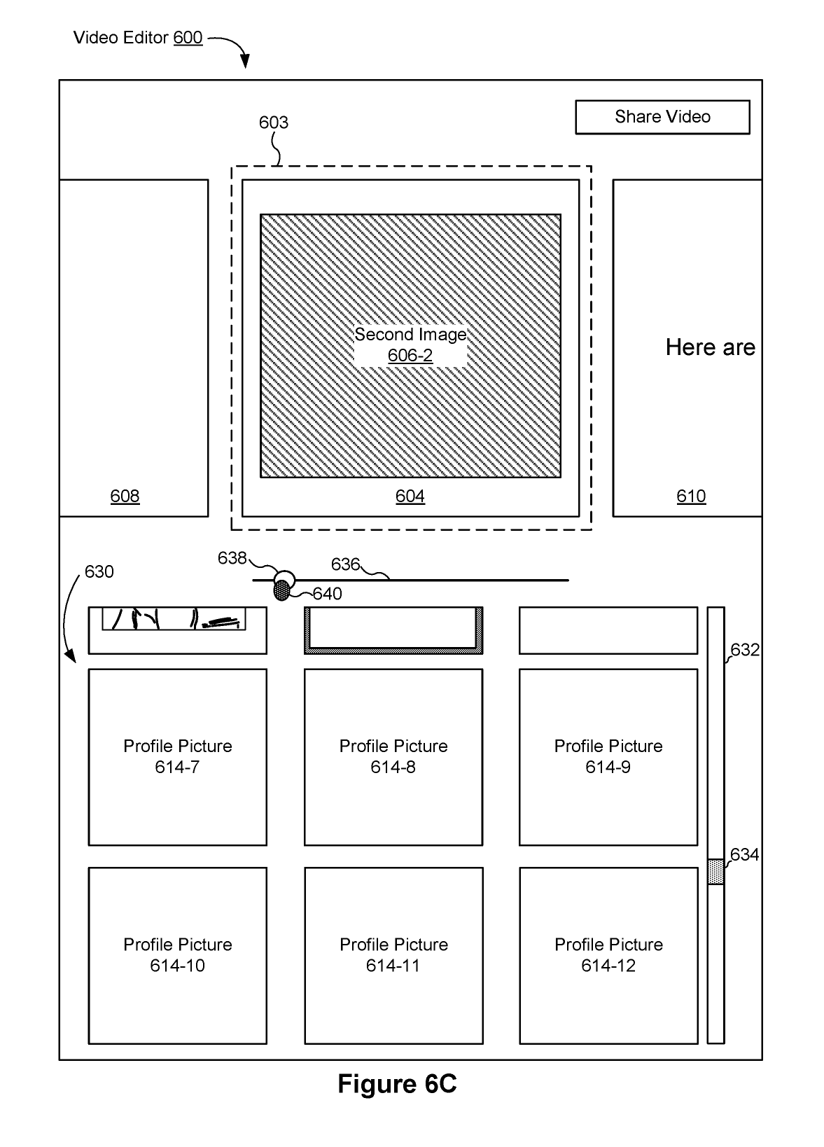

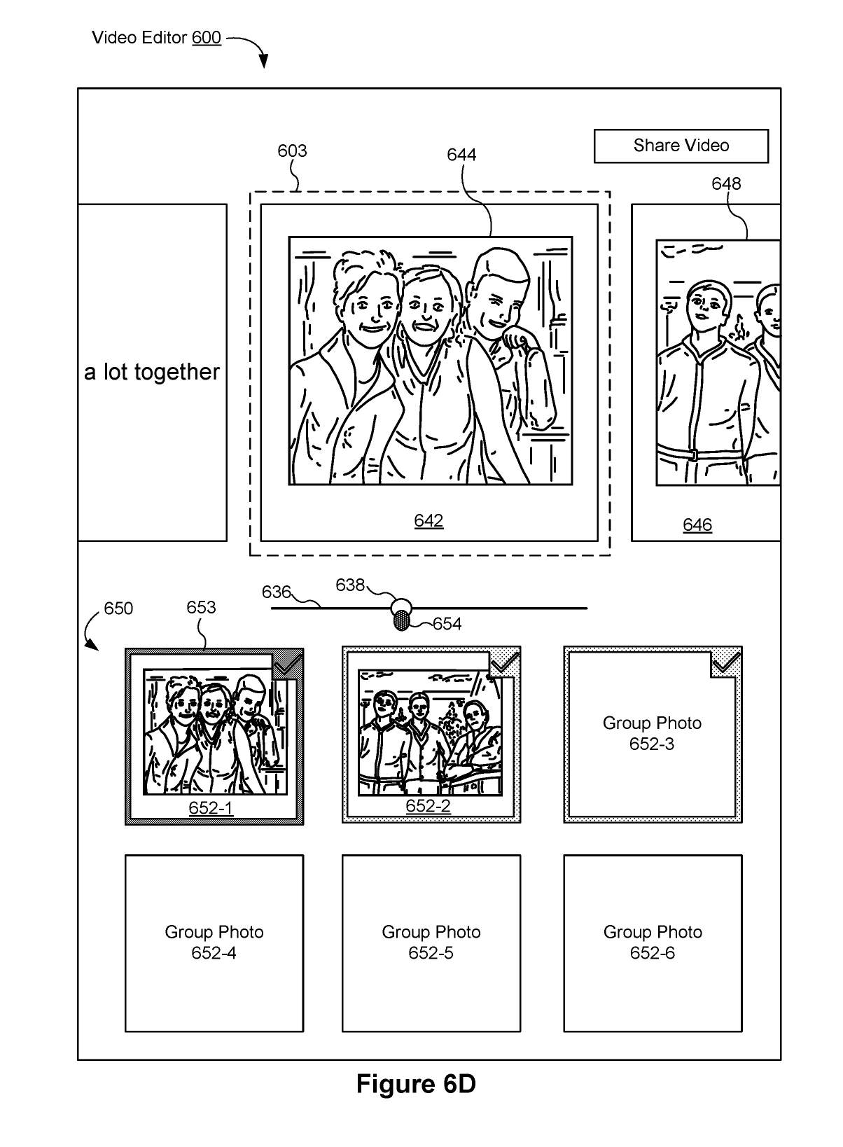

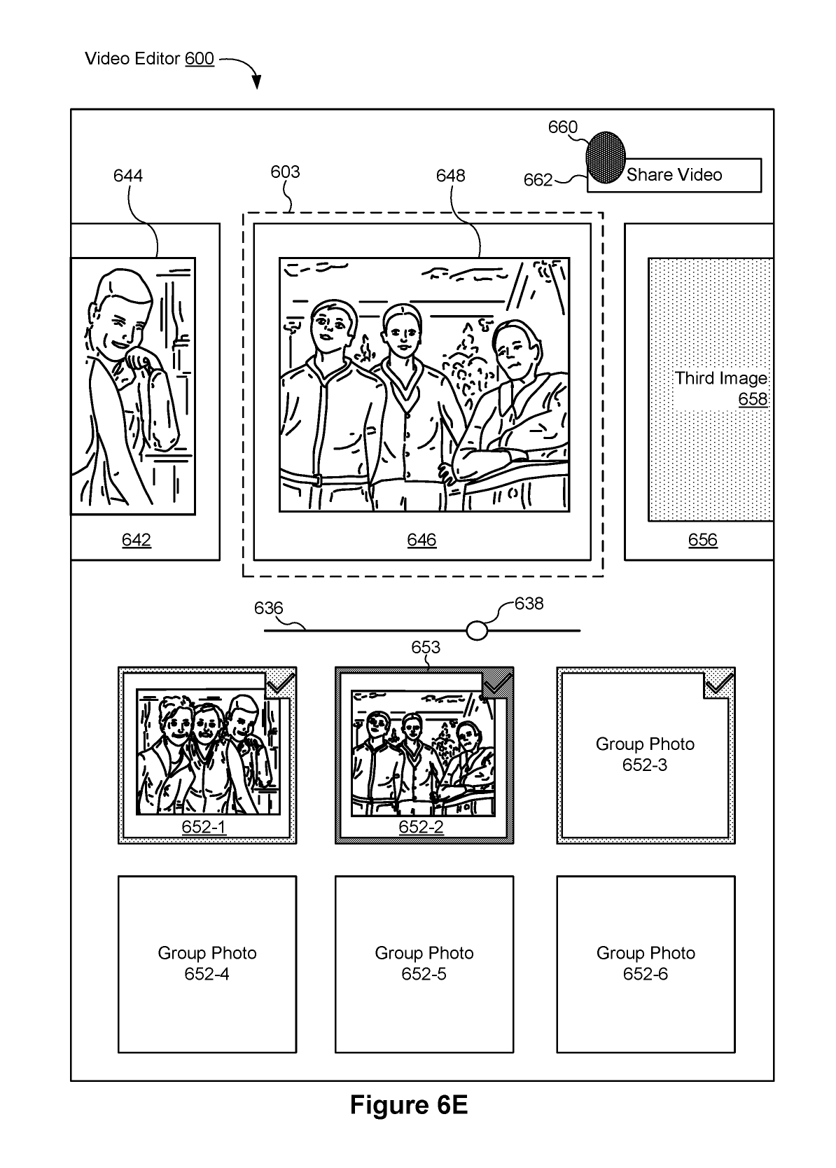

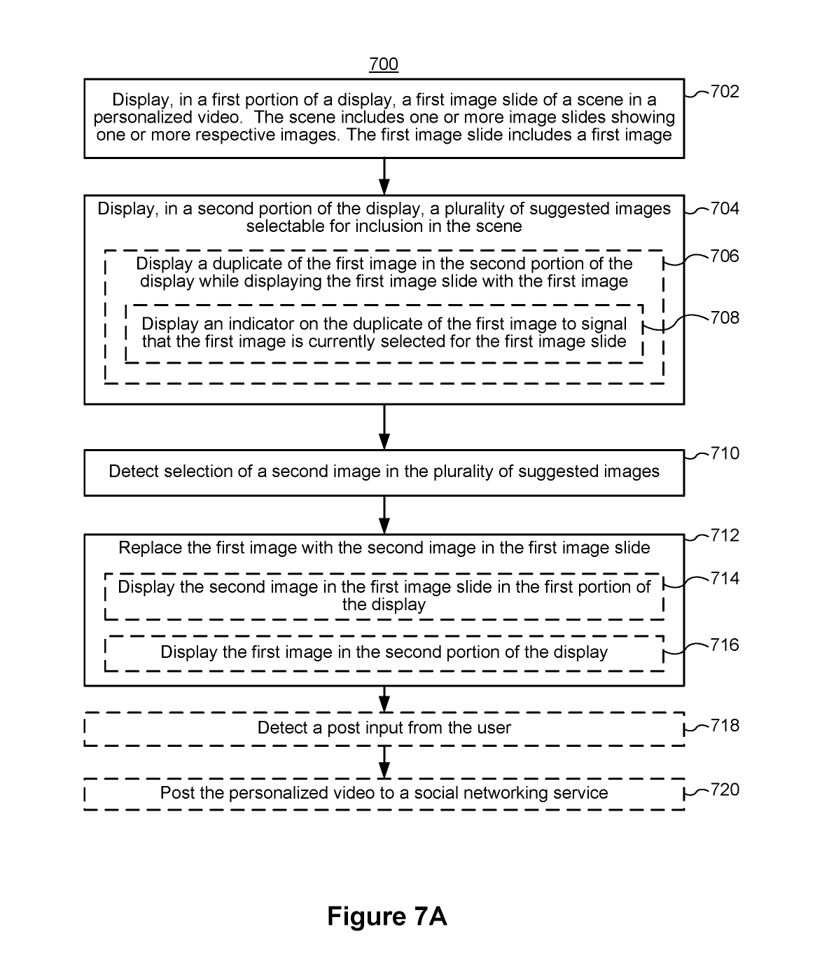

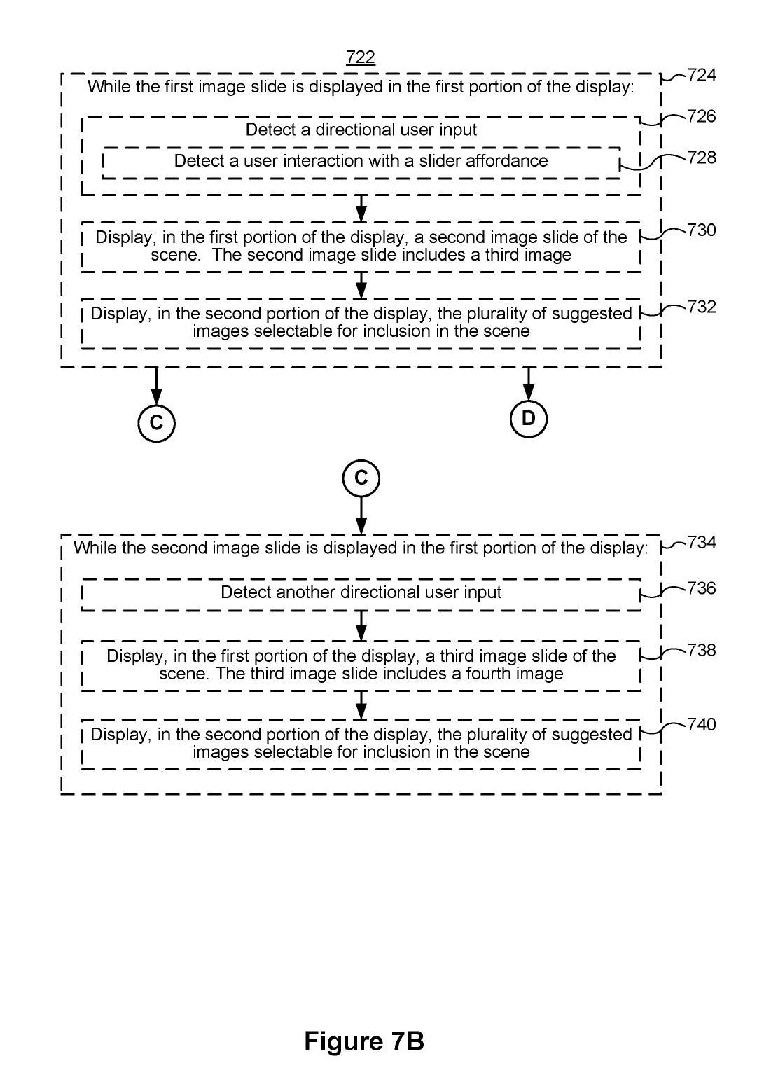

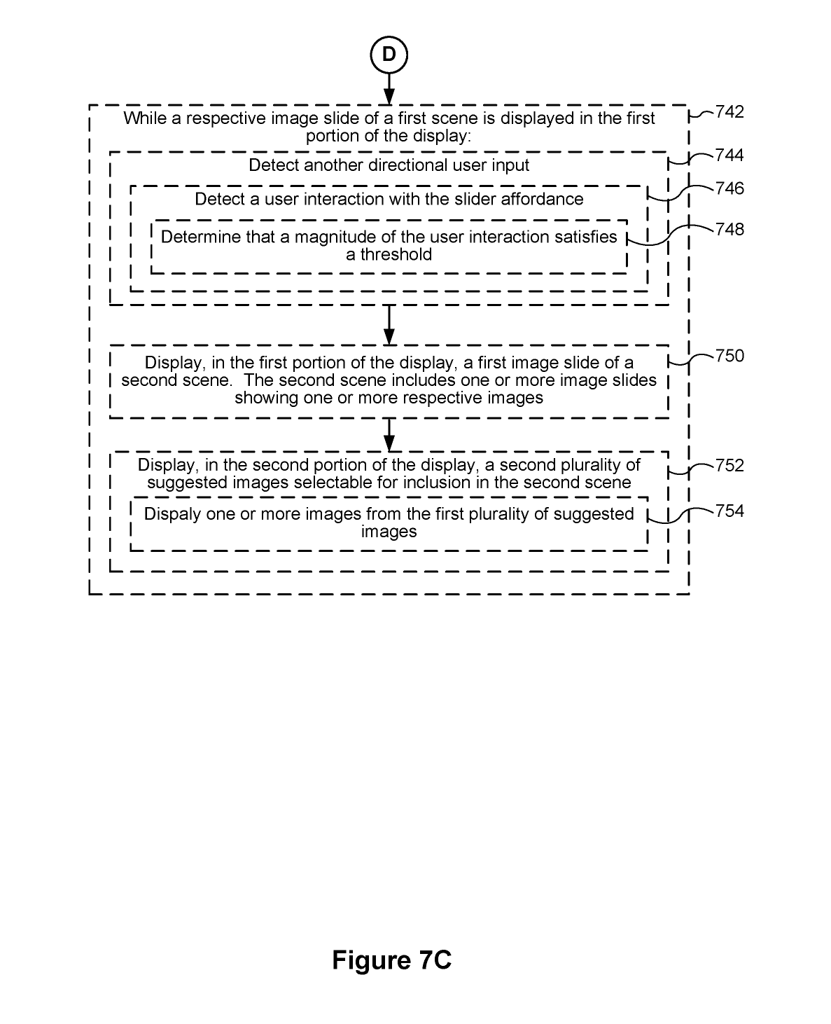

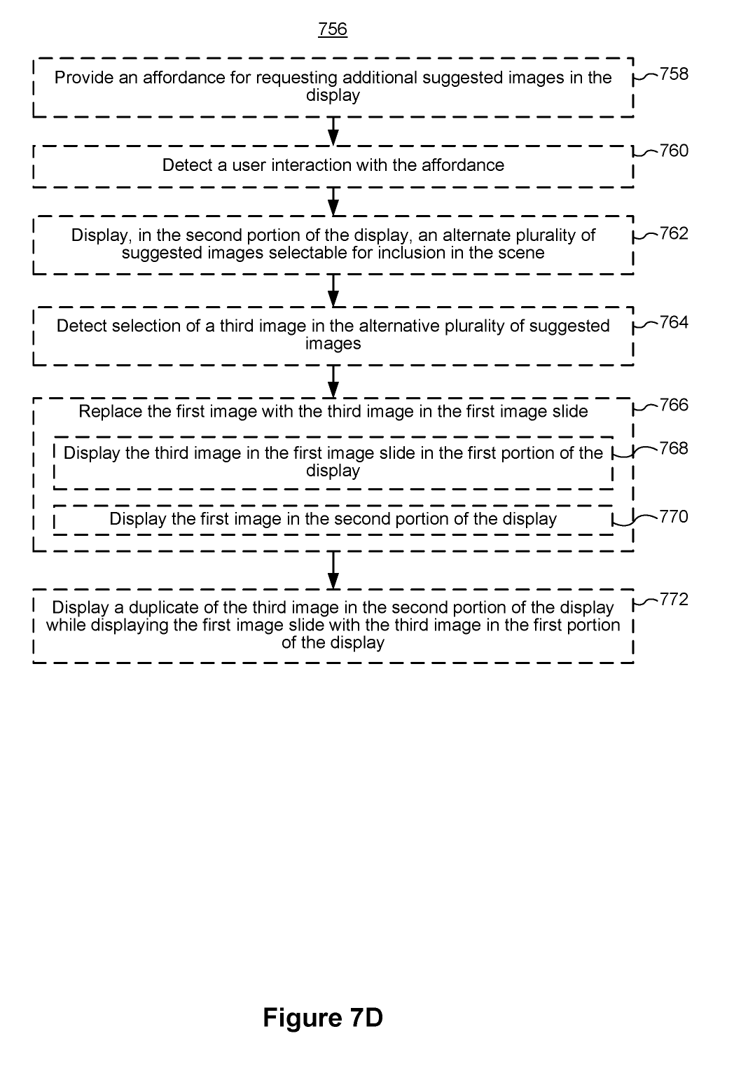

In some embodiments, the social networking system may select a second set of images from the plurality of images based at least in part on the respective metrics. In some embodiments, the second set of images may be alternatives to the first set of images. For example, the social networking system may provide the second set of images to the client device and a user may edit the personalized video, via the client device, by replacing one or more images from the first set of images with one or more images from the second set of images. Editing the personalized video is discussed in further detail below with reference to FIGS. 6A-6D and 7A-7D.

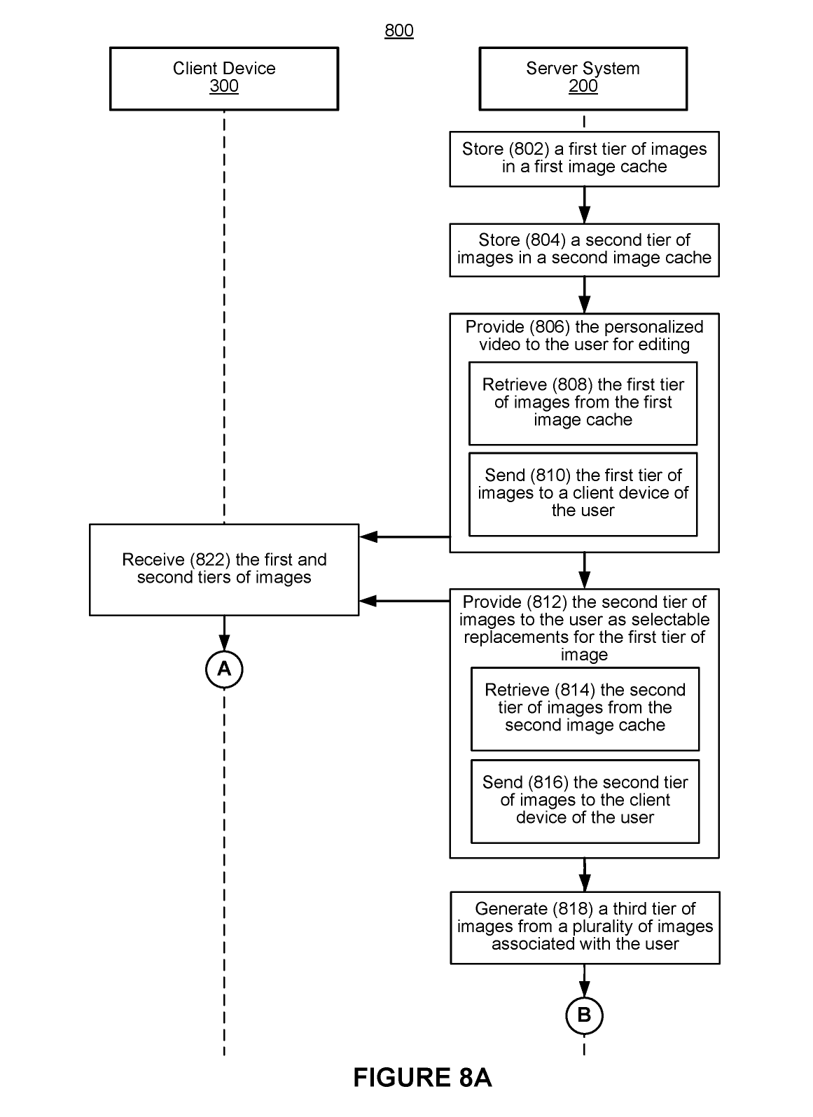

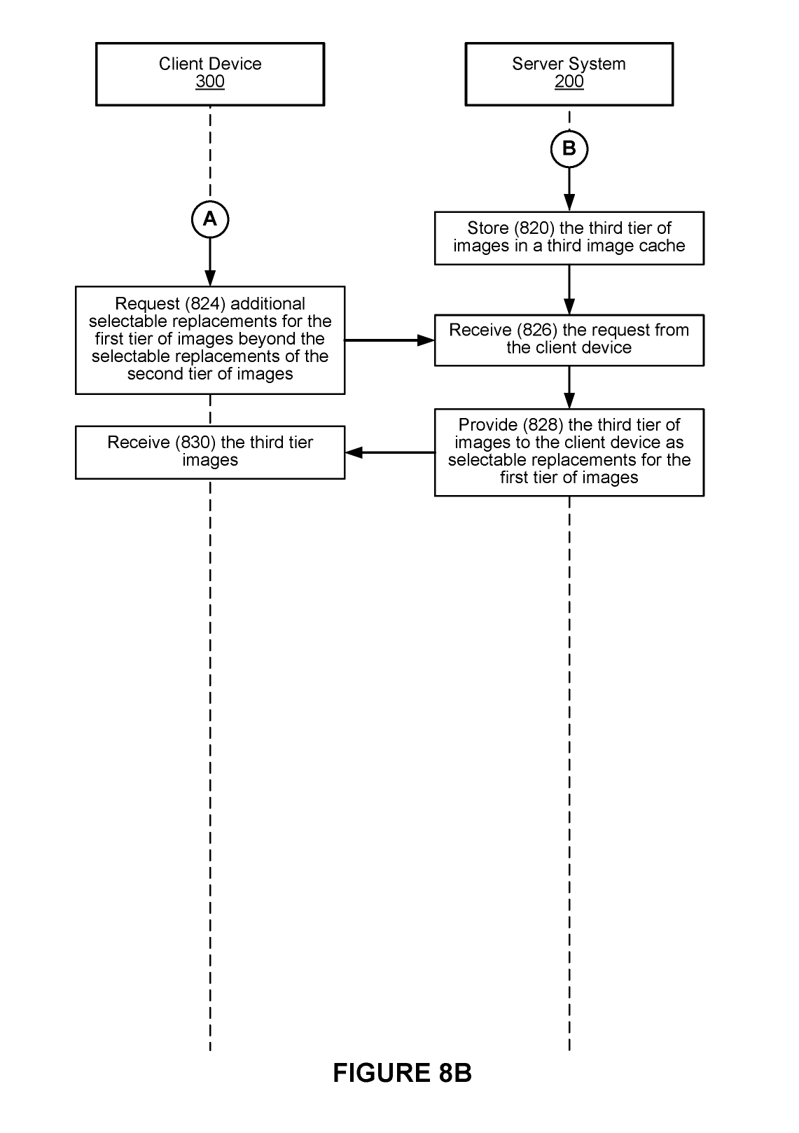

In some embodiments, the second set of images may be selected based at least in part on respective first metrics and/or second metrics, as discussed above with reference to selecting the first set of images. In some embodiments, the second set of images may include a first subset of images designated for a first scene in the personalized video, a second subset of images designated for a second scene in the personalized video, a third subset of images designated for a third scene in the personalized video, and so on. A respective subset of images for the second set of images may be associated with a respective subset of images for the first set of images. For example, a first subset of images for the first set of images may include images populated in the personalized video and a first subset of images for the second set of images may be presented as alternatives to the first subset of images for the first set of images (e.g., plurality of suggested images 612, FIG. 6A and/or plurality of suggested images 650, FIG. 6D). In some embodiments, a respective subset of images for the second set of images for a scene may include a first group of images and a second group of images. The social networking system may provide the first group of images for the respective subset to the client device when providing the personalized video to the client device (e.g., the plurality of suggested images 612, FIG. 6A). Moreover, the social networking system may provide the second group of images to the client device in response to a request for additional images from the client device (e.g., user selection 628, FIG. 6B, and the one or more additional images 630, FIG. 6C). In some embodiments, the second group of images may be an example of a third set of images. Alternatively, in some embodiments, the third set of images may be selected based at least in part on respective first metrics and/or second metrics, as discussed above with reference to selecting the first and second sets of images. Generating and selecting the third set of images is discussed in further detail below with reference to FIGS. 6B-6C and FIGS. 8A-8B.

In some embodiments, the social networking system, when selecting the second set of images from the plurality of images, may rank the plurality of images using the respective first metrics and/or the respective second metrics. Moreover, the social networking system may form a respective subset of images designated for a respective scene in the personalized video from the plurality of images (e.g., the respective subset of images may be profile pictures). Thereafter, the social networking system may rank the respective subset of images using the respective first metrics and/or the respective second metrics. Additionally, the social networking system may choose images for the second set of images (in addition to the first set of images) from the plurality of images in accordance with the ranking. For example, the social networking system may choose a number of images having the highest rank for the personalized video (or for a respective scene) for the first set of images and may also choose an additional number of images for the second set of images having rankings below the images chosen for the first set of images. As discussed above, the social networking system may divide the additional images into a first group of images (e.g., the plurality of suggested images 612, FIG. 6A) and a second group of images (e.g., the additional images 630, FIG. 6C). The social networking system may divide the additional messages into the respective first and second groups in accordance with the ranking. In some embodiments, the second set of images includes one or more images of the first set of images (e.g., duplicate images).

In some embodiments, the first set of images is an example of a first tier of images. In some embodiments, the second set of images is an example of a second tier of images. In some embodiments, the third set of images is an example of a third tier of images. The first, second, and third tiers of images are discussed in further detail with reference to FIGS. 8A-8B.

FIGS. 6A-6E illustrate exemplary graphical user interfaces (GUIs) of a personalized video editor on a client device in accordance with some embodiments. A social networking system (e.g., server system 200, FIG. 2) may generate the personalized video for a user of a social networking service. The generated personalized video may include images selected from a plurality of images associated with the user. The social networking system may populate the personalized video with the selected images and may provide the personalized video to the client device of the user (e.g., user 102-1, FIG. 1). The client device may display the personalized video in a video editor program 600 on a display 602 of the client device (e.g., display 312 of client device 300, FIG. 3). The user, via the client device, may interact with the video editor 600 to edit the personalized video provided by the social networking system. Generating and providing the personalized video to the client device is discussed in further detail above with reference to FIGS. 4A-4J and 5A-5D.

FIG. 6A illustrates an exemplary GUI of the video editor 600 for a first scene of the personalized video for the user. In some embodiments, the personalized video may include a plurality of scenes. For example, a respective scene of the plurality of scenes may be a profile picture scene and may include one or more image slides for profile pictures. In some embodiments, a first scene of the plurality of scenes may include one or more slides that may be displayed in a first portion of the display 602. The one or more slides may include one or more image slides (e.g., first image slide 604) of the first scene and may also include one or more text slides associated with the image slides. For example, text slide 608 may include text that is associated with content of the first image slide 604. Scenes, image slides, and text slides are discussed in further detail above with reference to FIGS. 4A-4J.

In some embodiments, the first image slide 604 may include a first image 606-1. The first image 606-1 may be related to the first scene (e.g., the first scene may be a profile picture scene and the first image 606-1 may be a profile picture of the user). In some embodiments, the social networking system may select the first image 606-1 from a first set of images and may populate the first image slide 604 with the first image 606-1. Selecting the first set of images and populating the personalized video are discussed in further detail above with reference to FIGS. 4A-4J and FIGS. 5A-5D.

In some embodiments, the video editor 600 includes an active slide area 603 in the first portion of the display 602. The active slide area 603 is an area that includes a slide (e.g., an image slide) for editing. For example, the user may interact with the video editor 600 to position a slide in the active slide area 603. In some embodiments, the user may select an image and the client device may populate the active slide area 603 with the selected slide. In some embodiments, the active slide area 603 may include the first image slide 604 for editing (e.g., editing may include replacing the first image 606-1 with another image). In some embodiments, the active slide area 603 may include a text slide for editing (e.g., text slides 608 or 610). The social networking system, when generating the personalized video, may generate text for the text slides 608 and 610. The user may edit the generated text in the text slides 608 and 610 by selecting one of the text slides (608 or 610) and amending the text to his or her liking.

In some embodiments, the social networking system may provide a plurality of suggested images 612. In some embodiments, the social networking system may select the plurality of suggested images 612 from a second set of images. For example, the plurality of suggested images 612 may be a subset (e.g., a first subset) of the second set of images. In some embodiments, the plurality of suggested images 612 may be profile pictures of the user (profile pictures 614-1, 614-2, 614-3, and so on). Selecting the second set of images is discussed in further detail above with reference to FIG. 5D.

The plurality of suggested images 612 may be alternate images for the first scene. For example, the user may select a respective image from the plurality of suggested images 612 to replace an image (e.g., the first image 606-1) in a respective image slide (e.g., first image slide 604) of the first scene. In some embodiments, each slide within the first scene may include a respective plurality of suggested images. In some circumstances and situations, a first respective plurality of suggested images (e.g., for a first image slide) and a second respective plurality of suggested images (e.g., for a second image slide) may include one or more overlapping images.

In some embodiments, the client device may display the plurality of suggested images 612 in a second portion of the display 602. In some embodiments, the second portion of the display 602 is a lower portion of the display 602 while the first portion of the display 602 may be an upper portion of the display (or vice versa). In some embodiments, the second portion of the display 602 is a left portion of the display while the first portion of the display may be a right portion of the display (or vice versa). In some embodiments, the plurality of suggested images 612 may be icon representations of the respective images of the plurality of suggested images 612. In some embodiments, the plurality of suggested images 612 may be thumbnail images, full-size images, and/or otherwise re-sized images.

In some embodiments, the social networking system may create a duplicate image of each image in the first set of images and may include the duplicates with the second set of images. In this way, the plurality of suggested images 612 (which may be derived from the second set of images) may include each image from the first set of images. Alternatively, the client device may create duplicate images for each image included in the personalized video after receiving the personalized video from the social networking system. In some embodiments, a duplicate image is an identical copy of the respective images in the first set of images. In some embodiments, a duplicate image differs in some respect from the respective images in the first set of images (e.g., different quality and/or different file type).

As such, in some embodiments, the first image slide 604 may include an original image (an image provided by the social networking system) and the plurality of suggested images 612 may include a duplicate image of the original image. For example, the first image 606-1 may be the original image and the profile picture 614-1 may be a duplicate (e.g., a copy) of the first image 606-1. Alternatively, in some embodiments, the first image slide 604 may include a duplicate image of a respective image in the plurality of suggested images 612. For example, the first image 606-1 in the first image slide 604 may be a duplicate of profile picture 614-1. Put another way, the profile picture 614-1 may be displayed in the second portion of the display 602 with the plurality of suggested images 612 while a copy of the profile picture 614-1 (e.g., first image 606-1) may be displayed in the first portion of the display 602. In some embodiments, the first image 606-1 may be removed from the plurality of suggested images 612 when included in the personalized video. Although the term “original image” is used, it should be understood that an original image may be a copy of an image stored at the social networking system (e.g., at the server system 200).

In some embodiments, a respective image of the plurality of suggested images 612, while displayed in the second portion of the display, may include one or more indicators to signal that the respective image is currently part of the personalized video. For example, the profile picture 614-1 is currently part of the personalized video. Consequently, the profile picture 614-1 may include one or more indicators to signal that a duplicate of the profile picture 614-1, the first image 606-1, is currently part of the personalized video. As mentioned above, the profile picture 614-1 may in some embodiments be the duplicate image while the first image 606-1 may be the original image.

In some embodiments, a first indicator of the one or more indictors may involve modifying a portion of the respective image. For example, a perimeter portion 616 of the profile picture 614-1 differs in color relative to other portions of the profile picture 614-1. Moreover, the perimeter portion 616 of the profile picture 614-1 differs in color from other images (e.g., profile pictures 614-2, 614-3, and so on) in the plurality of suggested images 612 as the other images are not currently part of the personalized video. In some embodiments, a second indicator of the one or more indicators may be a marker 618 positioned on a portion of the respective image. In some embodiments, the marker 618 may be a shape or a symbol. For example, the marker 618 may be a check-mark in a corner portion of the profile picture 614-1. Furthermore, the marker 618 may differ in color from other portions of the profile picture 614-1. In some embodiments, the marker 618 may be positioned within the perimeter portion 616 of the profile picture 614-1 and may differ in color from a color of the perimeter portion 616. Various shapes and symbols, in addition to the check-mark, may be used for the marker 618. Moreover, the one or more indictors may involve other indicators that may distinguish an image which is currently in the personalized video from other images which are not.

FIG. 6B illustrates an exemplary GUI of the video editor 600 for the first scene in response to a user selection 620 (FIG. 6A). In some embodiments, the user may replace content of the first image slide 604 (or whichever slide is in the active area 603) with other content (e.g., a respective image from the plurality of suggested images 612) by selecting the other content. For example, the user may want to replace the first image 606-1 (i.e., profile picture 614-1) with profile picture 614-2. As such, the user may select, via the client device, the profile picture 614-2 (e.g., user selection 620, FIG. 6A). The user may, for example, select the profile picture 614-2 by clicking on the profile picture 614-2 (e.g., via a mouse 316 or a touch sensitive display 314, FIG. 3). In another example, the user may replace the first image 606-1 (i.e., profile picture 614-1) by dragging and dropping the profile picture 614-2 into a portion of the first image slide 604.

In response to the user selection of the profile picture 614-2 (user selection 620, FIG. 6A), the client device may replace the first image 606-1 with a second image 606-2 in the first image slide 604. In some embodiments, the second image 606-2 is a duplicate image of the profile picture 614-2 in the plurality of suggested images 612, or vice versa. In some embodiments, the second image 606-2 may be removed from the plurality of suggested images 612 once included in the personalized video.

Moreover, in response to the user selection 620 of the profile picture 614-2 (FIG. 6A), the client device may remove the one or more indicators from the profile picture 614-1 as the profile picture 614-1 may no longer be part of the personalized video. Furthermore, the client device may display one or more indicators (e.g., indicators 622 and 624) on the profile picture 614-2 to signal that the profile picture 614-2 is currently part of the personalized video.

FIG. 6C illustrates an exemplary GUI of the video editor for the first scene in response to a user selection 628 of a button 626 (FIG. 6B). In some embodiments, the client device may request one or more additional images 630 from the social networking system (or a third-party server) in response to the user selection 628. In some embodiments, the social networking system may select the one or more additional images 630 from the second set of images. For example, the additional images 630 may be a subset (or a group) of the second set of images. In some embodiments, the plurality of suggested images 612 may be a first subset of the second set of images and the additional images 630 may be a second subset of the second set of images (also referred to herein as a third set of images). Thereafter, the social networking system (or the third-party server) may provide the one or more additional images 630 to the client device in response to receiving the request from the client device. Selecting the second set of images is discussed in further detail above with reference to FIG. 5D.

In response to receiving the additional images, the client device may populate the second portion of the display 602 with the one or more additional images 630. In some embodiments, the video editor 600 may include a scroll bar 632 in a portion (e.g., the first portion or the second portion) of the display. In some embodiments, the client device may provide the scroll bar 632 in accordance with a determination that a number of suggested images (e.g., the plurality of suggested images 612 and/or the additional images 630) in the second portion of the display satisfy a threshold. The user may scroll through the additional images 630 (and the plurality of suggested images 612 in some circumstances) using a selectable portion 634 of the scroll bar 632.

In some embodiments, the social networking system may store the one or more additional images 630 in an image cache (e.g., third image cache 242, FIG. 2) after selecting the one or more additional images 630 from the second set of images.

FIG. 6D illustrates an exemplary GUI of the video editor for a second scene in response to a user interaction 640 with a slider affordance 636. In particular, FIG. 6D illustrates a resulting GUI after the user moves 640 a slider portion 638 of the slider affordance 636 from a first position to a second position. A user may interact with the slider 638 of the slider affordance 636 to cycle (e.g., look) through slides of the personalized video. For example, when the user slides 640 the slider 638 in a first direction (e.g., to the right), a subsequent slide in the personalized video may be positioned within the active slide area 603. Moreover, when the user slides 640 the slider 642 in a second direction (e.g., to the left), a previous slide in the personalized video may be positioned within the active slide area 603. The user may move (e.g., translate) one or more slides through the active slide area 603 depending on an amount (e.g., a magnitude) of movement of the slider 638 by the user. For example, when the user slides 640 the slider 638 in a first direction by a threshold amount, an image slide of a subsequent scene may be positioned within the active slide area 603.

As shown, the active slide area 603 includes a second image slide 642 of a second scene (e.g., a group photo scene or another profile picture scene). In some embodiments, the second scene of the personalized video may include a plurality of image slides. For example, the second scene may include a first image slide 642 having a first image 644, a second image slide 648 having a second image 646 , and a third image slide having a third image (e.g., third image slide 556 and third image 658, FIG. 6E). In some embodiments, the social networking system may select the first, second, and third images from the first set of images and may populate the respective image slides with the first, second, and third images. Selecting the first set of images and populating the personalized video are discussed in further detail above with reference to FIGS. 4A-4J and FIGS. 5A-5D.

In some embodiments, the social networking system may provide a plurality of suggested images 650 to the client device. In some embodiments, the social networking system may select the plurality of suggested images 650 from the second set of images. For example, the plurality of suggested images 650 may be a subset (e.g., a second subset) of the second set of images. In some embodiments, the client device may display the plurality of suggested images 650 in the second portion of the display 650. In some embodiments, the plurality of suggested images 650 may be images of the user with other users of the social networking service (e.g., the user with contacts of the user). For example, the plurality of suggested images 650 may include group photos 652-1, 652-2, and so on. The plurality of suggested images 650 may be alternate images for the second scene. Selecting the second set of images is discussed in further detail above with reference to FIG. 5D.

In some embodiments, the social networking system may create a duplicate image of respective images (e.g., each image) in the first set of images and may place the duplicates in the second set of images. In this way, the plurality of suggested images 650 (which may be derived from the second set of images) may include each image from the first set of images. Alternatively, the client device may create duplicate images for each image included the personalized video after receiving the personalized video from the social networking system.

As such, in some embodiments, the first image slide 642 of the second scene may include an original image (an image provided by the social networking system) and the plurality of suggested images 650 may include a duplicate image of the original image. For example, the first image 644 may be the original image and the group photo 652-1 may be a duplicate (e.g., a copy) of the first image 644. Alternatively, in some embodiments, the first image 644 (and/or the second and third images) may be removed from the plurality of suggested images 650 if included in the personalized video. Duplicates are discussed in further detail above with reference to FIG. 6A.

In some embodiments, a respective image of the plurality of suggested images 650, while displayed in the second portion of the display, may include one or more indicators to signal the user that the respective image is currently part of the personalized video. For example, the group photo 652-1 may include one or more indicators to signal that a duplicate image of the group photo 652-1, the first image 644, is currently part of the personalized video. The group photos 652-2 and 652-3 may also include one or more indicators as both images are currently part of the personalized video. The one or more indicators are discussed in further detail above with reference to FIG. 6A.

In some embodiments, when a respective scene includes two or more image slides, a respective image of the plurality of suggested images 650 that is currently positioned in the active slide area 603 may include an additional indicator 653 to signal the user that the respective image is currently positioned in the active slide area 603. In some embodiments, the additional indicator 653 may include modifying a portion of the respective image that is currently positioned in the active slide area 603. For example, a perimeter/border portion of the image (e.g., group photo 652-1) may differ in color (e.g., a darker color) from perimeter/border portions of other images included in the respective scene (e.g., group photos 652-2 and 652-3). In some embodiments, the additional indicator 653 may include increasing a thickness of the perimeter portion of the respective image or changing a shape of the respective image in the second portion of the display. In some embodiments, the additional indicator 653 may include placing a marker on a portion of the image that differs from markers on other images included in the respective scene (e.g., group photos 652-2 and 652-3).

FIG. 6E illustrates an exemplary GUI of the video editor for the second scene in response to a user interaction 654 with the slider affordance 636 (FIG. 6D). In particular, FIG. 6E illustrates a resulting GUI of the video editor 600 after the user moves 654 the slider 638 from the second position to a third position. As shown, the active slide area 603 includes the second image slide 646 of the second scene. Furthermore, the second slide 646 includes the second image 648 of the second scene.

In response to the user interaction 654 with the slider affordance 636, the client device may transfer the additional indicator 653 from the group photo 652-1 to the group photo 652-2. In some embodiments, the client device may transfer the additional indicator 653 to the group photo 652-2 as the duplicate image of the group photo 652-2, the second image 648, is the image currently displayed in the active slide area 603 (or vice versa).

In response to a user selection 660 of a share video button 662, the client device may post the personalized video to the social networking service. Alternatively, in some embodiments, the client device may signal (e.g., request) the social networking system to post and/or otherwise share the personalized video in response to the user selection 660 of the share video button 662.

FIGS. 7A-7D are flow diagrams illustrating a method 700 of editing a personalized video (using a video editor program, such as video editor 600) for a user of a social networking system, in accordance with some embodiments. The steps of the method 700 may be performed by any combination of client device (e.g., a client device 104, FIG. 1; client device 300, FIG. 3) and/or social networking system (e.g., social network system 108, FIG. 1; server system 200, FIG. 2). FIGS. 7A-7D correspond to instructions stored in a computer memory or computer readable storage medium (e.g., memory 206 of the social network system 200; memory 306 of the client device 300). For example, the operations of the method 700 are performed, at least in part, by a social network server module (e.g., social network server module 226, FIG. 2) and/or client application modules (e.g., client application modules 336, FIG. 3).

In performing the method 700, the client device displays (702), in a first portion of a display, a first image slide of a scene in a personalized video. In some embodiments, the scene may include one or more image slides showing one or more respective images. The first image slide (e.g., first image slide 604, FIG. 6A) may include a first image (e.g., first image 606-1, FIG. 6A) of the one or more respective images for the scene. In some embodiments, the scene is a first scene in a plurality of scenes (e.g., a profile picture scene or a group picture scene). Moreover, the one or more respective images of the scene may be a subset (e.g., a first subset of images) of the first set of images discussed above with reference to step 520 of the method 500 and FIG. 6A. Consequently, the first image may be an image from the first set of images or more specifically an image of the first subset of images. In some embodiments, the scene may include one or more text slides having text relating to the scene. Scenes and image slides are discussed in further detail above with reference to FIG. 6A.

In some embodiments, the social networking system (e.g., server system 200, FIG. 2) provides, to the client device, the first image for the first image slide. Alternatively or in addition, a third-party server may provide the first image for the first image slide to the client device.

In some embodiments, the client device displays (704), in a second portion of the display, a plurality of suggested images (e.g., the plurality of suggested images 612, FIG. 6A) selectable for inclusion in the scene. In some embodiments, the plurality of suggested images may include one or more images of the second set of images. For example, the social networking system may designate a subset of images of the second set of images for a particular scene. As such, the plurality of suggested images may be the designated subset of images for the scene. A user of the video editor program may select a respective image from the plurality of suggested images for inclusion in the scene (e.g., a user may select a respective image by clicking and/or touching the respective image via the client device). The plurality of suggested images is discussed in further detail above with reference to FIG. 6A.

In some embodiments, the social networking system may provide, to the client device, the plurality of suggested images for display in the second portion of the display. Alternatively or in addition, a third-party server may provide the plurality of suggested images for display in the second portion of the display.

In some embodiments, while displaying the first image slide with the first image in the first portion of the display, the client device may display (706) a duplicate of the first image in the second portion of the display. For example, the first image in the first image slide may be part of the first set of images and therefore the first image may not initially be included in the second portion of the display with the plurality of suggested images as the plurality of suggested images may be part of the second set of images. As such, the social networking system (or the client device) may create a duplicate of the first image and the client device may display the duplicate in the plurality of suggested images. Duplicate images are discussed in further detail above with reference to FIGS. 6A-6D.

Furthermore, in some embodiments, the client device may display (708) one or more indicators on the duplicate of the first image to signal (e.g., the user) that the first image is currently selected for the first image slide (e.g., indicators 616 and 618, FIG. 6A). Moreover, the client device may display the one or more indicators on each image within the plurality of suggested images that is part of the personalized video. For example, a scene may include a plurality of image slides showing a plurality of respective images. In some circumstances and situations, the client device may display respective duplicates of the plurality of respective images in the second portion of the display with the suggested plurality of images. In these circumstances and situations, the respective duplicates of the plurality of respective images may include the one or more indicators (e.g., one or more indicators displayed on group photos 652-1, 652-2, and 652-3, FIG. 6D). The one or more indicators are discussed in further detail above with reference to FIGS. 6A-6D.

In some embodiments, the client device may detect (710) selection of a second image in the plurality of suggested images (e.g., user selection 620, FIG. 6A). In some embodiments, in response to detecting the selection of the second image, the client device may replace (712) the first image with the second image in the first image slide. Moreover, the client device may display (714) the second image in the first image slide in the first portion of the display when replacing the first image with the second image in the first image slide (e.g., the first image 606-1 is replaced with the second image 606-2, FIGS. 6A-6B). Furthermore, in some embodiments, the client device may display (716) the first image in the second portion of the display in response to detecting the selection of the second image. For example, the client device may discard the first image (e.g., the first image 606-1, FIG. 6A) and maintain the duplicate of the first image in the plurality of suggested images, or vice versa (e.g., profile picture 614-1, FIG. 6B). In another example, the client device may swap positions of the first image and the second image. Replacing images in the personalized video is discussed in further detail above with reference to FIGS. 6A-6D.

In some embodiments, the social networking system may receive a request, from the client device, to replace the first image with the second image of the plurality of suggested images. Furthermore, in response to receiving the request to replace the first image with the second image, the social networking system may update the first image slide as stored at the social networking system to include the second image in place of the first image.

In some embodiments, the client device may detect (718) a post input from the user (e.g., share video button 664, FIG. 6E). In response to detecting the post input, the client device may post (720) the personalized video to a social networking service (e.g., a social networking service provided by the social networking system 108, FIG. 1). In some embodiments, the social networking system may receive a request to post and/or otherwise share the personalized video from the client device and may post/share the personalized video to the social networking service in response to receiving the request.

In some embodiments, the method 700 may include method 722. The steps of the method 722 may be performed in conjunction with the steps of the method 700. For example, the steps of the method 722 may be performed after step 704 of the method 700. In another example, the steps of the method 722 may be performed after step 712 of the method 700.

As such, in some embodiments, while displaying the first image slide in the first portion of the display (724), the client device may detect (726) a directional user input. In some embodiments, the client device may detect the directional user input on an affordance provided by the client device (or the social networking system). For example, the affordance may be a button on a portion of the display (e.g., next or previous button). In some embodiments, the client device may provide a slider affordance in a portion of the display and the client device may detect the directional user input by detecting user interaction with the slider affordance (728). For example, the user may slide a slider portion of the slider affordance in a first direction (e.g., slider affordance 636 includes a slider 638, FIG. 6C).

In response to detecting the directional user input, the client device may display (730), in the first portion of the display, a second image slide of the scene (e.g., displays the second image slide 646 in the active slide area 603, FIG. 6D). For example, the client device may translate the first image slide (e.g., first image slide 642, FIG. 6D) in a direction (e.g., to the left) and may translate the second image slide (e.g., first image slide 646, FIG. 6D) in the direction. As discussed above, the scene may include one or more image slides showing one or more respective images. Accordingly, the second image slide may include a third image. The third image may be a respective image of the one or more respective images for the scene. In some embodiments, the third image may be an image from the first set of images. The first set of images is discussed in further detail above with reference to FIGS. 5A-5D and FIGS. 6A-6D.

Furthermore, in response to detecting the directional user input, the client device may display (732), in the second portion of the display, the plurality of suggested images selectable for inclusion in the scene. In some embodiments, the directional user input may move the slider affordance by a first amount. In accordance with a determination that movement of the slider affordance by the first amount does not satisfy a first threshold, the client device maintains display of the plurality of suggested images.

In some embodiments, while displaying the second image slide in the first portion of the display (734), the client device may detect (736) another directional user input. In some embodiments, the client device may detect the other directional user input on the affordance provided by the client device (or the social networking system). For example, the affordance may be the button on the portion of the display (e.g., next or previous button) or the slider affordance.

In response to detecting the other directional user input, the client device may display (738), in the first portion of the display, a third image slide of the scene. The third image slide may include a fourth image (e.g., an image from the one or more respective images). In some embodiments, the fourth image may be an image from the first set of images. Furthermore, in response to detecting the directional user input, the client device may display (740), in the second portion of the display, the plurality of suggested images selectable for inclusion in the scene. In some embodiments, the other directional user input may move the slider affordance by a second amount. In accordance with a determination that movement of the slider affordance by the second amount does not satisfy the first threshold, the client device maintains display of the plurality of suggested images.

In some embodiments, the plurality of suggested images is a first plurality of suggested images and the scene is a first scene of a plurality of scenes in the personalized video. Furthermore, while displaying a respective image slide (e.g., the first, second, or third image slides) of the first scene in the first portion of the display (742), the client device may detect (744) a directional user input. In some embodiments, the client device may detect the directional user input on the affordance (e.g., the button affordance) provided by the client device (or the social networking system). In some embodiments, the client device may detect the directional user input by detecting the user interaction with the slider affordance (746). In some embodiments, the device may determine (748) that a magnitude of the user interaction with the slider affordance satisfies a second threshold. In response to such a determination, the client device may switch from a first scene in the personalized video to a second scene in the personalized video. For example, the first scene may refer to profile pictures (e.g., FIGS. 6A-6C) and the second scene may refer to group photos of the user with other users of the social networking service (e.g., FIGS. 6D-6E).

In some embodiments, in response to detecting the directional user input (744), the client device may display (750), in the first portion of the display, a first image slide of a second scene (e.g., group photo scene, FIG. 6D). The second scene may include one or more image slides showing one or more respective images. Accordingly, the first image slide of the second scene may include a first image of the one or more respective images. Moreover, the one or more respective images of the second scene may be a subset (e.g., a second subset of images) of the first set of images discussed above with reference to step 520 of the method 500 and FIGS. 6D-6E. Consequently, the first image of the second scene may be an image from the first set of images or more specifically an image of the second subset of images.

Furthermore, in response to detecting the directional user input, the client device may display (752), in the second portion of the display, a second plurality of suggested images selectable for inclusion in the second scene (e.g., the plurality of suggested images 650, FIG. 6D). In some embodiments, the second plurality of suggested images does not include any images from the first plurality of suggested images. In some embodiments, the second plurality of suggested images may include one or more images from the first plurality of suggested images (754).

In some embodiments, the client device may request the social networking system to provide the one or more respective images and the second plurality of suggested images for the second scene. In some embodiments, the social networking system may provide the one or more respective images and the second plurality of suggested images for the second scene in response to receiving the request from the client device. Alternatively, the social networking system may provide the one or more respective images and the second plurality of suggested images for the second scene when it provides the one or more respective images and the first plurality of suggested images for the first scene.

In some embodiments, the method 700 may include method 756. The steps of the method 756 may be performed in conjunction with the steps of the method 700 as well as the method 722. For example, the steps of the method 722 may be performed after step 704 of the method 700. In another example, the steps of the method 722 may be performed after step 712 of the method 700.

In some embodiments, the client device (or the social networking system) may provide (758) an affordance for requesting additional suggested images in the display (e.g., load more photos button 626, FIG. 6B). In some embodiments, the additional suggested images may a subset of images of the second set of images. For example, the plurality of suggested images (e.g., the plurality of suggested images 612, FIG. 6A) may be a first subset of images of the second set of images and the additional suggested images may be a second subset of images of the second set of images. Selecting the images for the second set of images is discussed in further detail above with reference to FIG. 5D.

Furthermore, in some embodiments, the client device may detect (760) a user interaction with the affordance (e.g., user selection 628, FIG. 6B). In response to detecting the user interaction with the affordance, the client device may request the additional suggested images from the social networking system. In some embodiments, the social networking system may generate the additional suggested images in response to receiving a request from the client device. The social networking system may generate (e.g., select) the additional suggested images using the first and/or second metrics, as discussed above with respect to selecting the first and second sets of images (FIGS. 5A-5D). Alternatively, in some embodiments, the social networking system may generate (e.g., select) the additional suggested images when generating (e.g., selecting) the plurality of suggested images for a respective scene, or after providing the personalized video to the client device. Providing the additional suggested images is discussed in further detail below with reference to FIGS. 8A-8B.

In response to detecting the user interaction with the affordance (and in some embodiments, in response to receiving the additional suggested images from the social networking system), the client device may display (762), in the second portion of the display, an alternate plurality of suggested images selectable for inclusion in the scene (e.g., the additional suggested images 630, FIG. 6C). In some embodiments, the client device may include the alternate plurality of suggested images with the plurality of suggested images in the second portion of the display. In this way, the user may cycle through both pluralities of suggested images when editing the personalized video. For example, the user may use a scroll bar (e.g., scroll bar 632, FIG. 6C) to cycle through the suggested images.

In some embodiments, the client device may detect (764) selection of an image in the alternative plurality of suggested images (e.g., profile picture 614-7, FIG. 6C). In response to detecting the selection of the image, the client device may replace (766) a current image in the first image slide (e.g., the first image 606-1 or the second image 606-2, FIGS. 6A and 6C) with the selected image. In some embodiments, when replacing the current image with the selected image in the first image slide, the client device may display (768) the selected image in the first image slide in the first portion of the display and may display (770) the current image in the second portion of the display. Replacing content in an image slide is discussed in further detail above with reference to FIGS. 6A-6D.

In some embodiments, while displaying the first image slide with the selected image in the first portion of the display, the client device may display (772) a duplicate of the selected image in the second portion of the display. For example, the selected image may be displayed in a first image slide (e.g., first image slide 604, FIG. 6C) and a duplicate of the selected image may be displayed with the alternative plurality of suggested images. Duplicates are discussed in further detail above with reference to FIG. 6A.

FIGS. 8A-8B are flow diagrams illustrating a method 800 of storing and providing content for a personalized video to a user of a social networking system, in accordance with some embodiments. The steps of the method 800 may be performed by any combination of client device (e.g., a client device 104, FIG. 1; client device 300, FIG. 3) and/or server system (e.g., social network system 108, FIG. 1; server system 200, FIG. 2). FIGS. 8A-8B correspond to instructions stored in a computer memory or computer readable storage medium (e.g., memory 206 of the social network system 200; memory 306 of the client device 300). For example, the operations of the method 800 are performed, at least in part, by a social network server module (e.g., social network server module 226, FIG. 2) and/or client application modules (e.g., client application modules 336, FIG. 3).

In performing the method 800, the server system 200 may store (802) a first tier of images in a first image cache (e.g., first image cache 238, FIG. 2). In some embodiments, the first tier of images may be an example of the first set of images. As discussed above, the server system 200 may select a first set of images from a plurality of images associated with a user (users 102-1, 102-2, . . . 102-n, FIG. 1) of a social networking service to be included in a personalized video provided to the user (e.g., client device 300) by the server system 200. The first set of images may be selected based at least in part on respective metrics (e.g., respective first metrics and/or respective second metrics). Accordingly, the images of the first tier are included in the personalized video provided to the user by the server system 200.

In some embodiments, a first respective image of the first tier may be included in an initial image slide (e.g., initial image slide 402, FIG. 4A) of the personalized video, a second respective image of the first tier may be included in a subsequent image slide of the personalized video, and so on. In some embodiments, the images of the first tier may be equal in number to a number of image slides included in the personalized video. In some embodiments, the personalized video is a personalized slideshow video. Determining respective first metrics and/or second metrics and selecting images for the first set of images is discussed in further detail above with reference to FIGS. 5A-5D.

In some embodiments, the server system 200 may define a plurality of scenes for the personalized video (e.g., a first scene may be a profile picture scene, a second scene may be a group photo scene, etc.). In some embodiments, the first tier of images may include respective images for respective image slides in the plurality of scenes. For example, a first respective image (e.g., first image 606-1, FIG. 6A) of the first tier of images may be included in a first image slide (e.g., first image slide 604, FIG. 6A) of a first scene while a second respective image (e.g., first image 644, FIG. 6D) of the first tier of images may be included in a first image slide (e.g., first image slide 642, FIG. 6D) of a second scene. In some embodiments, the first tier of images may include a respective image for each image slide of each scene. For example, a scene of the plurality of scenes may include, say, three image slides (e.g., image slides 642, 646, and 656, FIGS. 6D-6E). Accordingly, the first tier of images may include respective images for each image slide in the scene. In addition, the first tier of images may include respective images for each image slide in the remaining scenes of the plurality of scenes.

In performing the method 800, the server system 200 may store (804) a second tier of images in a second image cache (e.g., second image cache 240, FIG. 2). In some embodiments, the second tier of images may be an example of the second set of images. As discussed above, the server system 200 may select a second set of images from the plurality of images associated with the user that may be presented as alternatives to the first set of images by the server system 200. The second set of images may be selected based at least in part on respective metrics (e.g., respective first metrics and/or respective second metrics). In some embodiments, the images of the second tier may be presented as alternatives to the images of the first tier. For example, the server system 200 may include the first tier of images in the personalized video for the user and may present the second tier of images to the user. The user may replace one or more images included in the personalized video with one or more images from the second tier of images (e.g., user selection 620, FIG. 6A). Determining respective first metrics and/or second metrics and selecting images for the second set of images is discussed in further detail above with reference to FIG. 5D.

In some embodiments, the second tier of images may include a plurality of replacement images (also referred to herein as a plurality of suggested images and/or additional images) for the plurality of scenes (e.g., for each scene of the plurality of scenes). For example, the second tier of images may include a first plurality of replacement images (e.g., the plurality of suggested images 612, FIG. 6A) for a first scene (e.g., a profile picture scene) and may include a second plurality of replacement images (e.g., the plurality of suggested images 650, FIG. 6D) for a second scene (e.g., a group picture scene). In some embodiments, the first plurality of replacement images of the second tier of images may be an example of the first subset of images for the second set of images (discussed above with respect to FIG. 5D). In addition, in some embodiments, the second plurality of replacement images of the second tier of images may be an example of the second subset of images for the second set of images (discussed above with respect to FIG. 5D).

In some embodiments, the second tier of images may include a plurality of replacement images for respective slides (e.g., each image slide) of respective scenes of the plurality of scenes. For example, the second tier of images may include a first plurality of replacement images (e.g., the plurality of suggested images 612, FIG. 6A) for a first respective image (e.g., first image 606-1, FIG. 6A) in a first image slide (e.g., image slide 604) of a first scene. Furthermore, in some embodiments, the second tier of images may include a plurality of replacement images for each slide of each scene of the plurality of scenes. For example, the user may replace a respective text slide within the personalized video with a respective image from the plurality of replacement images. In this way, the user may replace a text slide with an image slide.

In some embodiments, when storing the second tier of images in the second image cache, the server system 200 may store duplicate images for respective images in the first tier in the second image cache. In this way, a respective plurality of replacement images of the second tier of images may include images (e.g., each image) from the first tier of images. Duplicates are discussed in further detail above with reference to FIGS. 6A-6E.

In some embodiments, the server system 200 may provide (806) the personalized video to the user for editing (e.g., provide to the client device 300). In some embodiments, the server system 200 may provide the personalized video to the user in response to receiving a request for a personalized video from the client device 300. The client device 300 may detect a request from the user for the personalized video (e.g., detect the request when the user interacts with a webpage or an application for the social networking service). In response to detecting the request, the client device 300 may request a personalized video for the user from the server system 200. Alternatively, in some embodiments, the server system 200 may provide the personalized video to the client device 300 absent a request from the client device 300. For example, the server system 200 may provide personalized videos to respective users (e.g., each user) of the social networking service at a specified time and/or date (e.g., on an anniversary, on a day of a month, on a day of a year, etc.).

In some embodiments, when providing the personalized video to the user, the server system 200 may retrieve (808) the first tier of images from the first image cache (e.g., the first image cache 238, FIG. 2) and may send (810) the first tier of images to the client device 300. In some embodiments, the server system 200 may populate image slides of the personalized video with respective images from the first tier when providing the personalized video to the client device 300 (e.g., image slide 402 includes image 404, FIG. 4A). In some embodiments, the server system may populate the personalized video with one or more text slides that have text associated with the images in the first tier (e.g., text slide 408, FIG. 4B).

In some embodiments, the server system 200 may provide (812) the second tier of images to the user as selectable replacements for the first tier of images. In some embodiments, the server system 200 may provide the second tier of images when it provides the first tier of images (e.g., first and second tiers of images may be received simultaneously by the client device 300). In some embodiments, the server system 200 may provide the first tier of images at a first time and may provide the second tier of images at a second time. For example, the server system 200 may provide the first tier of images in the personalized video and, at some point thereafter, may provide the second tier of images in response to receiving a request from the client device 300 (e.g., the user of the client device 300 may request to edit the personalized video via a video editor program, such as video editor 600). In some embodiments, when providing the personalized video, the server system 200 may retrieve (814) the second tier of images from the second image cache (e.g., second image cache 240, FIG. 2) and may send (816) the second tier of images to the client device 300. In some embodiments, when retrieving the second tier of images from the second image cache, the server system may retrieve the duplicate images for respective images in the first tier.

In some embodiments, the server system 200, when sending the second tier of images to the client device 300, may send a first plurality of replacement images for a first scene of the personalized video. For example, a first scene may be a profile picture scene and the first plurality of replacement images designated for the first scene may be replacement profile pictures. In some embodiments, the server system 200 may retrieve the first plurality of replacement images for the first scene from the second image cache using a first suggestion algorithm. In some embodiments, the first suggestion algorithm is based at least in part on a ranking of images in the second image cache. For example, the server system 200 may choose, say, ten of the highest ranked profile pictures when retrieving the first plurality of replacement images for the first scene (e.g., a profile picture scene). In some embodiments, the first suggestion algorithm may be based on a ranking of a respective subset of images in the second image cache. Ranking images is discussed in further detail above with reference to FIGS. 5A-5D.

In some embodiments, the server system 200, when sending the second tier of images to the client device 300, may send a second plurality of replacement images for a second scene of the personalized video. For example, a second scene may be a group photo scene and the second plurality of replacement images designated for the second scene may be replacement group photos. In some embodiments, the server system 200 may retrieve the second plurality of replacement images from the second image cache using a second suggestion algorithm. In some embodiments, the second suggestion algorithm may be based on a ranking of another respective subset of images in the second image cache, as discussed above.

In some embodiments, in response to sending the first and second tiers of images to the client device 300, the server system 200 may generate (818) (e.g., select) of a third tier of images. In some embodiments, the server system may select the third tier of images from a plurality of images associated with the user of the social networking service (e.g., selected from profile pictures 242 and other pictures associated with the user 244, FIG. 2). In some embodiments, the third tier of images may be selected based at least in part on respective metrics (e.g., respective first metrics and/or respective second metrics). In some embodiments, the third tier of images may be an example of the third set of images. Determining respective first metrics and/or second metrics and selecting images for the third set of images is discussed in further detail above with reference to FIG. 5D and FIGS. 6B-6C.

Alternatively or in addition, in some embodiments, the server system 200 may select the third tier of images when selecting the second tier of images (e.g., when selecting the second set of images for a respective scene). For example, the second tier of images (i.e., the second set of images) may include a first subset of images designated for a first scene in the personalized video, a second subset of images designated for a second scene in the personalized video, and so on. In some embodiments, a respective subset of images of the second tier of images for a scene may include a first group of images and a second group of images. The first group of images may be an example of the first plurality of replacement images (e.g., the plurality of suggested images 612, FIG. 6A). The second group of images may be the third tier of images (e.g., the additional images 630, FIG. 6C). In some embodiments, the server system may rank images in the respective subset of images to determine the contents of the first and second groups (e.g., the first group of images may have a higher rank than the second group of images).

In some embodiments, the server system 200 may generate (e.g., select) the third tier of images in response to receiving a request (e.g., request 826) from the client device 300. For example, referring to FIG. 6B, the server system 200 may generate (e.g., select) the images for the third tier of images in response to user selection 628 of button 626.

In some embodiments, the server system 200 may store (820) the third tier of images in a third image cache (e.g., third image cache 242, FIG. 2) after generating the third tier of images.

In some embodiments, the client device 300 may receive (822) the personalized video from the server system 200. Alternatively, in some embodiments, the client device 300 may stream the personalized video from a location (e.g., at the server system 200). In some embodiments, the personalized video includes the first tier of images. In addition, in some embodiments, the client device 300 may receive the second tier of images. In some embodiments, the server system 200 may divide the second tier of images into respective subsets of images designated for respective scenes in the personalized video (e.g., a first respective subset of images from the second tier of images may be replacement profile pictures for a profile picture scene). Accordingly, in some embodiments, the client device 300 may receive one or more respective subsets of images from the second tier of images.

In some embodiments, the client device 300 may request (824) additional selectable replacements for the first tier of images beyond the selectable replacements of the second tier of images. For example, in some circumstances or situations, a user may find the second tier of images (e.g., images in a respective subset of images) to be unsatisfactory replacements for the first tier of images. In these circumstances or situations, the user of the client device 300 may interact with the client device 300 (e.g., select an affordance provided in the video editor program 600) to request the additional selectable replacements (e.g., user selection 628 of button 626, FIG. 6B).

In some embodiments, the server system 200 may receive (826) the request from the client device 300 for the additional selectable replacements. For example, the server system 200 may receive a request for additional selectable replacements for a respective scene of the plurality of scenes. In some embodiments, in response to receiving the request, the server system 200 may provide (828) the third tier of images to the client device 300 as the additional selectable replacements for the first tier of images (e.g., additional images 630, FIG. 6C). In some embodiments, the server system 200 may provide the third tier of images (e.g., the second group of images from the second tier of images) to the client device 300 as the additional selectable replacements for the first tier of images in the respective scene. In some circumstances, the third tier of images may include one or more duplicate images already provided in the first tier of images and/or the second tier of images. In these circumstances, the server system 200 may identify the one or more duplicate images and may exclude the one or more duplicate images when providing the third tier of images to the client device 300.

In some embodiments, the client device 300 may receive (830) the third tier of images from the server system 200. In some embodiments, the server system 200 may divide the third tier of images into respective subset of images designated for respective scenes in the personalized video (e.g., a first respective subset of images from the third tier of images may be replacement profile pictures for a profile picture scene). Accordingly, in some embodiments, the client device 300 may receive one or more respective subsets of images from the third tier of images.

In some circumstances or situations, a user may find currently displayed images of the third tier of images (e.g., a first portion of the third tier of images) to be unsatisfactory replacements for the first tier of images. In these circumstances or situations, the user may interact with the client device 300 to request additional replacement images (e.g., user may interact with scroll bar 632, FIG. 6C). In response to detecting user interaction with the scroll bar (e.g., user scrolls down), the client device 300 may request additional selectable replacements for the first tier of images beyond the selectable replacements of the second tier of images and the currently displayed images of the third tier of images. In some embodiments, in response to receiving the request, the server system 200 may provide additional images from the third image cache (e.g., a second portion of the third tier of images). In some embodiments, the client device 300 may periodically request additional selectable replacements for the first tier of images in accordance with user interaction with the scroll bar (e.g., a third portion of the third tier of images, a fourth portion of the third tier of images, and so on).

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a server system having one or more processors and memory storing instructions for execution by the one or more processors:
storing a first tier of images in a first image cache, wherein the images of the first tier are included in a personalized video for a user;
storing a second tier of images in a second image cache, wherein the images of the second tier are alternatives to the images of the first tier;
providing the personalized video to the user for editing, comprising retrieving the first tier of images from the first image cache and sending the first tier of images to a client device of the user; and
providing the second tier of images to the user as selectable replacements for the first tier of images, comprising retrieving the second tier of images from the second image cache and sending the second tier of images to the client device of the user.

2. The method of claim 1, further comprising, at the server system:
receiving a request, from a client device of the user, for additional selectable replacements for the first tier of images beyond the selectable replacements of the second tier of images; and
in response to the request, providing a third tier of images to the client device as selectable replacements for the first tier of images.

3. The method of claim 2, further comprising, at the server system, storing the third tier of images in a third image cache.

4. The method of claim 1, further comprising, at the server system:
defining a plurality of scenes for the personalized video, wherein each scene includes one or more image slides; wherein:
the first tier of images includes respective images for respective image slides of each scene; and
the second tier of images includes a plurality of replacement images for each scene.

5. The method of claim 4, wherein the first tier of images includes a respective image for each image slide of each scene.

6. The method of claim 4, wherein the second tier of images includes a plurality of replacement images for each slide of respective scenes of the plurality of scenes.

7. The method of claim 6, wherein the second tier of images includes a plurality of replacement images for each slide of each scene of the plurality of scenes.

8. The method of claim 4, wherein the plurality of scenes includes:
a profile-picture scene comprising one or more image slides for one or more profile pictures of the user and contacts of the user;
a first group scene comprising one or more image slides for group images of the user with contacts of the user; and
a second group scene comprising a slide at a designated position in the personalized video for a group image of the user with contacts of the user.

9. The method of claim 8, wherein:
the server system provides a social networking service; and
the contacts of the user are friends of the user in the social networking service.

10. The method of claim 8, wherein:
the slide at the designated position is a final image slide in the personalized video; and
the group image, for the second scene, includes at least four people.

11. The method of claim 4, wherein sending the second tier of images to the client device of the user comprises:
sending a first plurality of replacement images for a first scene of the personalized video, wherein the first plurality of replacement images are retrieved from the second image cache using a first suggestion algorithm; and
sending a second plurality of replacement images for a second scene of the personalized video, wherein the second plurality of replacement images are retrieved from the second image cache using a second suggestion algorithm.

12. The method of claim 4, wherein:
respective scenes of the plurality of scenes further include one or more text slides; and
the one or more text slides include text associated with the respective scenes.

13. The method of claim 4, further comprising, at the server system:
receiving a request for additional selectable replacements for a respective scene of the plurality of scenes; and
in response to the request, providing a third tier of images to the client device as selectable replacements for the first tier of images in the respective scene.

14. The method of claim 1, wherein:
storing the second tier of images in the second image cache comprises storing duplicate images for respective images in the first tier; and
retrieving the second tier of images from the second image cache comprises retrieving the duplicate images.

15. The method of claim 1, wherein the personalized video is a personalized slideshow video.

16. A server system, comprising:
a processor; and
memory storing one or more programs for execution by the processor, the one or more programs including instructions for:
storing a first tier of images in a first image cache, wherein the images of the first tier are included in a personalized video for a user;
storing a second tier of images in a second image cache, wherein the images of the second tier are alternatives to the images of the first tier;
providing the personalized video to the user for editing, comprising retrieving the first tier of images from the first image cache and sending the first tier of images to a client device of the user; and
providing the second tier of images to the user as selectable replacements for the first tier of images, comprising retrieving the second tier of images from the second image cache and sending the second tier of images to the client device of the user.

17. The system of claim 16, wherein:
storing the second tier of images in the second image cache comprises storing duplicate images for respective images in the first tier; and
retrieving the second tier of images from the second image cache comprises retrieving the duplicate images.

18. The system of claim 16, further comprising, at the server system:
receiving a request, from a client device of the user, for additional selectable replacements for the first tier of images beyond the selectable replacements of the second tier of images; and
in response to the request, providing a third tier of images to the client device as selectable replacements for the first tier of images.

19. The system of claim 18, further comprising, at the server system, storing the third tier of images in a third image cache.

20. A non-transitory computer-readable storage medium, storing one or more programs configured for execution by one or more processors of a client device, the one or more programs including instructions for:
storing a first tier of images in a first image cache, wherein the images of the first tier are included in a personalized video for a user;
storing a second tier of images in a second image cache, wherein the images of the second tier are alternatives to the images of the first tier;
providing the personalized video to the user for editing, comprising retrieving the first tier of images from the first image cache and sending the first tier of images to a client device of the user; and
providing the second tier of images to the user as selectable replacements for the first tier of images, comprising retrieving the second tier of images from the second image cache and sending the second tier of images to the client device of the user.
